(19) United States
(12) Patent Application Publication
(10) Pub. No.: US 2007/0001983 A1
(43) Pub. Date: Jan. 4, 2007

(54) Integrated circuit device and electronic instrument

(75) Inventors: Satoru Ito, Suwa-shi (JP); Masahiko Moriguchi, Suwa-shi (JP); Kazuhiro Maekawa, Chino-shi (JP); Takashi Kumagai, Chino-shi (JP); Hisanobu Ishiyama, Chino-shi (JP); Takashi Fujise, Shiojiri-shi (JP); Junichi Karasawa, Tatsuno-machi (JP); Satoru Kodaira, Chino-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/477,718

(22) Filed: Jun. 30, 2006

(30) Foreign Application Priority Data
Jun. 30, 2005 (JP) 2005-192479
Feb. 10, 2006 (JP) 2006-034497

(51) Int. Cl. G09G 3/36

(52) U.S. Cl. 345/98

(57) ABSTRACT

An integrated circuit device includes a data driver block for driving data lines. The data driver block includes a plurality of subpixel driver cells, each of which outputs a data signal corresponding to image data of one subpixel. When a direction along the long side of the subpixel driver cell is a direction D1 and a direction perpendicular to the first direction is a direction D2, the subpixel driver cells are disposed in the data driver block along the direction D1 and the direction D2. Pads are disposed on the D2 side of the data driver block. A rearrangement wiring region for rearranging the order of pull-out lines of output signals from the subpixel driver cells is provided in the arrangement region of the subpixel driver cells.

Japanese Patent Application No. 2006-34497, filed on Feb. 10, 2006, and Japanese Patent Application No. 2005-192479, filed on Jun. 30, 2005, are hereby incorporated by reference in its entirety.

### BACKGROUND OF THE INVENTION

The present invention relates to an integrated circuit device and an electronic instrument.

A display driver (LCD driver) is an example of an integrated circuit device which drives a display panel such as a liquid crystal panel (JP-A-2001-222249). A reduction in the chip size is required for the display driver in order to reduce cost.

However, the size of the display panel incorporated in a portable telephone or the like is almost constant. Therefore, if the chip size is reduced by merely shrinking the integrated circuit device as the display driver by using a microfabrication technology, it becomes difficult to mount the integrated circuit device.

### SUMMARY

A first aspect of the invention relates to an integrated circuit device comprising at least one data driver block for driving data lines, the data driver block including;

a plurality of subpixel driver cells, each of the subpixel driver cells outputting a data signal corresponding to image data of one subpixel,

when a direction along a long side of the subpixel driver cell is a first direction and a direction perpendicular to the first direction is a second direction, the subpixel driver cells being disposed in the data driver block along the first direction and the second direction,

pads for electrically connecting output lines of the data driver block with the data lines being disposed on the second direction side of the data driver block,

a rearrangement wiring region for rearranging order of pull-out lines of output signals from the subpixel driver cells being provided in an arrangement region of the subpixel driver cells.

A second aspect of the invention relates to an electronic instrument comprising:

the above integrated circuit device;

and a display panel driven by the integrated circuit device.

### BRIEF DESCRIPTION OF THE SEVERAL VIEWS OF THE DRAWING

FIGS. 1A, 1B, and 1C are illustrative of a comparative example of one embodiment of the invention.

FIGS. 2A and 2B are illustrative of mounting of an integrated circuit device.

FIG. 3 is a configuration example of an integrated circuit device according to one embodiment of the invention.

FIG. 4 is an example of various types of display drivers and circuit blocks provided in the display drivers.

FIGS. 5A and 5B are planar layout examples of the integrated circuit device according to one embodiment of the invention.

FIGS. 6A and 6B are examples of cross-sectional views of the integrated circuit device.

FIG. 7 is a circuit configuration example of the integrated circuit device.

FIGS. 8A, 8B, and 8C are illustrative of configuration examples of a data driver and a scan driver.

FIGS. 9A and 9B are configuration examples of a power supply circuit and a grayscale voltage generation circuit.

FIGS. 10A, 10B, and 10C are configuration examples of a D/A conversion circuit and an output circuit.

FIGS. 11A and 11B are views illustrative of a memory/data driver block division method.

FIG. 12 is a view illustrative of a method of reading image data a plurality of times in one horizontal scan period.

FIG. 13 is an arrangement example of data drivers and driver cells.

FIG. 14 is an arrangement example of subpixel driver cells.

FIG. 15 is an arrangement example of sense amplifiers and memory cells.

FIG. 16 is a view illustrative of a pad wiring method according to a comparative example.

FIG. 17 is a view illustrative of a pad wiring method according to one embodiment of the invention.

FIGS. 18A and 18B are views illustrative of usage of aluminum wiring layers and the like.

FIG. 19 is a view illustrative of a wiring method for grayscale voltage supply lines.

FIG. 20 is a configuration example of the subpixel driver cell.

FIG. 21 is a configuration example of a D/A converter.

FIGS. 22A, 22B, and 22C are views illustrative of a truth table of a sub decoder of the D/A converter and a layout of the D/A converter.

FIGS. 23A and 23B illustrate a configuration example of an electronic instrument.

### DETAILED DESCRIPTION OF THE EMBODIMENT

The invention may provide an integrated circuit device which can reduce the circuit area, and an electronic instrument including the same.

One embodiment of the invention relates to an integrated circuit device comprising at least one data driver block for driving data lines, the data driver block including;

a plurality of subpixel driver cells, each of the subpixel driver cells outputting a data signal corresponding to image data of one subpixel,

when a direction along a long side of the subpixel driver cell is a first direction and a direction perpendicular to the first direction is a second direction, the subpixel driver cells being disposed in the data driver block along the first direction and the second direction,

pads for electrically connecting output lines of the data driver block with the data lines being disposed on the second direction side of the data driver block,

a rearrangement wiring region for rearranging order of pull-out lines of output signals from the subpixel driver cells being provided in an arrangement region of the subpixel driver cells.

According to this embodiment, the subpixel driver cells are disposed along the first direction (long side direction) and the second direction perpendicular to the first direction. The pads for electrically connecting the output lines of the data driver block (subpixel driver cells) with the data lines are disposed on the second direction side of the matrix-arranged subpixel driver cells. The order of the pull-out lines of the output signals from the subpixel driver cells is rearranged in the rearrangement wiring region. In this embodiment, the rearrangement wiring region is provided in the arrangement region of the subpixel driver cells. Therefore, a change in the wiring layer in the wiring region between the pads and the data driver block can be minimized, whereby the width of the wiring region in the second direction can be reduced. As a result, the area of the integrated circuit device can be reduced.

In the integrated circuit device according to this embodiment, the order of the pull-out lines may be rearranged in the rearrangement wiring region corresponding to order of the pads.

This allows the pull-out lines to be arranged corresponding to the order of the pads, whereby wiring of connection lines in the wiring region between the pads and the data driver block can be simplified.

In the integrated circuit device according to this embodiment, the order of the pull-out lines belonging to a first group may be rearranged in a first rearrangement wiring region, the pull-out lines belonging to the first group being the pull-out lines of the output signals from the subpixel driver cells belonging to a first group; and wherein the order of the pull-out lines belonging to a second group may be rearranged in a second rearrangement wiring region, the pull-out lines belonging to the second group being the pull-out lines of the output signals from the subpixel driver cells belonging to a second group.

This allows the order of the pull-out lines belonging to the first group to be rearranged in the first rearrangement wiring region and allows the order of the pull-out lines belonging to the second group to be rearranged in the second rearrangement wiring region. Therefore, since the order of the pull-out lines can be rearranged in a plurality of rearrangement wiring regions, the width of the wiring region between the pads and the data driver block in the second direction can be further reduced.

In the integrated circuit device according to this embodiment, in a wiring region between an arrangement region of the pads and the data driver block, connection lines for connecting the pull-out lines belonging to the first group and the pads may be provided using wiring in a given layer, and connection lines for connecting the pull-out lines belonging to the second group and the pads may be provided using wiring in a layer differing from the given layer.

This allows the connection lines for connecting the pull-out lines belonging to the first group and the pads and the connection lines for connecting the pull-out lines belonging to the second group and the pads can be overlapped, whereby the width of the wiring region between the pads and the data driver block can be further reduced in the second direction.

In the integrated circuit device according to this embodiment, a pull-out position change line for changing a pull-out position of the pull-out line may be provided in the rearrangement wiring region.

This allows the order of the pull-out lines to be rearranged by arbitrarily changing the pull-out position of the pull-out line of the output line of the subpixel driver cell.

In the integrated circuit device according to this embodiment, the pull-out position change line may be provided along the first direction across the subpixel driver cells disposed along the first direction.

This allows the pull-out line of the output line of the subpixel driver cell to be pulled out at an arbitrary position in the rearrangement wiring region along the first direction.

In the integrated circuit device according to this embodiment, two of the pull-out position change lines may be provided across two of the subpixel driver cells disposed along the first direction.

This allows the pull-out lines of the output lines of two subpixel driver cells arranged along the first direction to be pulled out at arbitrary positions in the rearrangement wiring region along the first direction.

In the integrated circuit device according to this embodiment, an image data supply line for supplying image data to the subpixel driver cell may be provided in the subpixel driver cell along the first direction using wiring in the same layer as the pull-out position change line.

This allows the image data supply line and the pull-out position change line to be provided using a single wiring layer, whereby the wiring efficiency can be increased.

In the integrated circuit device according to this embodiment, the pull-out line may be provided along the second direction using wiring in a layer differing from the pull-out position change line.

This allows the pull-out line and the pull-out position change line to be provided to intersect, whereby the wiring efficiency can be increased.

In the integrated circuit device according to this embodiment, the subpixel driver cell may include a D/A converter which performs D/A conversion of image data using a grayscale voltage; and a grayscale voltage supply line for supplying the grayscale voltage to the D/A converter may be provided in the data driver block along the second direction across the subpixel driver cells using wiring in the same layer as the pull-out line.

This allows the grayscale voltage to be efficiently supplied to the D/A converters of the subpixel driver cells disposed along the second direction through the grayscale voltage supply line provided along the second direction, whereby the layout efficiency can be improved. Moreover, the grayscale voltage supply line can be provided by effectively utilizing the free space of the pull-out line wiring region.

In the integrated circuit device according to this embodiment, the grayscale voltage supply line may be provided in an arrangement region of the D/A converter.

When the D/A converter includes a grayscale voltage selector or the like, it is preferable to provide the grayscale voltage supply line in the arrangement region of the grayscale voltage selector.

In the integrated circuit device according to this embodiment, an N-type transistor region and a P-type transistor region may be disposed along the second direction in an arrangement region of the D/A converter of the subpixel driver cell; and an N-type transistor region and a P-type transistor region may be disposed along the first direction in an arrangement region of a circuit of the subpixel driver cell other than the D/A converter.

This allows the grayscale voltage supply line to be connected in common with an N-type transistor in the N-type transistor region and a P-type transistor in the P-type transistor region disposed along the second direction, whereby the layout efficiency can be improved. On the other hand, an efficient layout along the signal flow may be achieved by disposing an N-type transistor region and a P-type transistor region of a circuit other than the D/A converter along the first direction.

In the integrated circuit device according to this embodiment, each of the subpixel driver cells may include: a first circuit region in which a circuit which operates using a power supply at a first voltage level is disposed; and a second circuit region in which a circuit which operates using a power supply at a second voltage level higher than the first voltage level is disposed; and the subpixel driver cells may be disposed so that the second circuit regions or the first circuit regions of the subpixel driver cells are adjacent to each other along the first direction.

This allows the width of the integrated circuit device in the first direction to be reduced in comparison with a method of disposing the subpixel driver cells so that the first circuit region is adjacent to the second circuit region, whereby the area of the integrated circuit device can be reduced.

The integrated circuit device according to this embodiment may comprise at least one memory block which stores the image data, wherein the memory block may be disposed adjacent to the first circuit region of the subpixel driver cell.

This allows the memory block which operates using a power supply at the first voltage level and the first circuit region of the subpixel driver cell to be adjacently disposed, whereby the layout efficiency can be improved.

A further embodiment of the invention relates to an electronic instrument comprising the above integrated circuit device and a display panel driven by the integrated circuit device.

These embodiments of the invention will be described in detail below. Note that the embodiments described below do not in any way limit the scope of the invention laid out in the claims herein. In addition, not all of the elements of the embodiments described below should be taken as essential requirements of the invention.

### 1. COMPARATIVE EXAMPLE

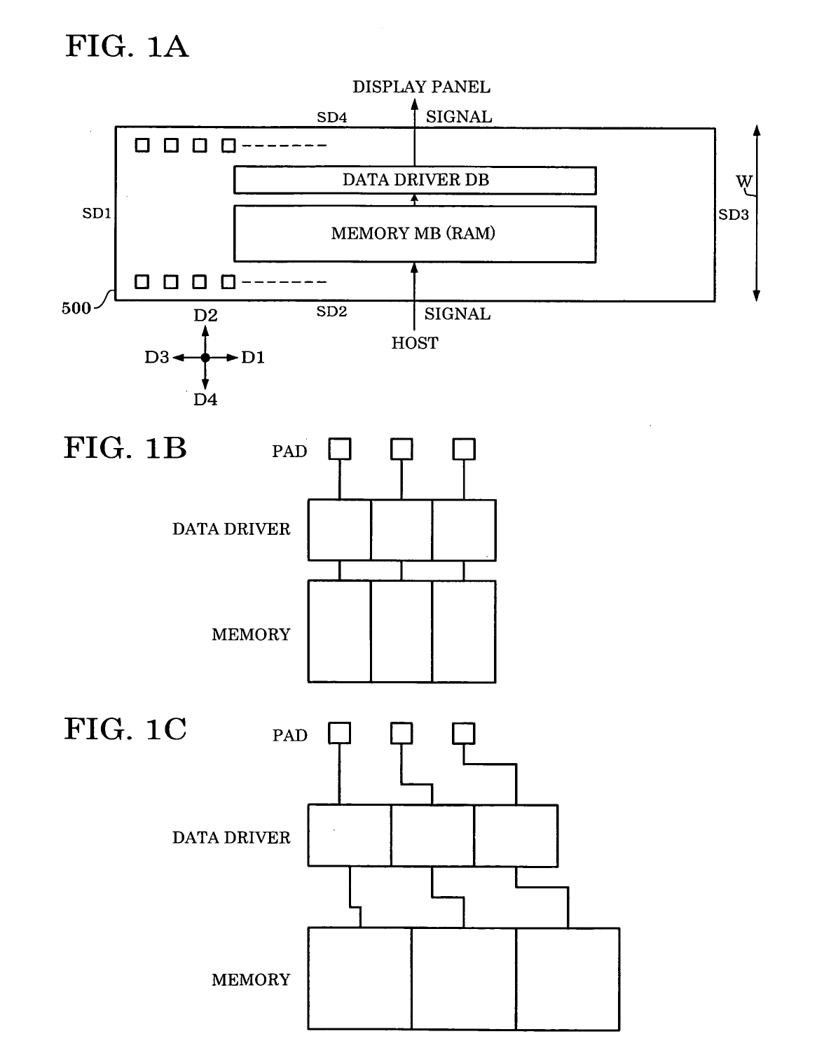

FIG. 1A shows an integrated circuit device 500 which is a comparative example of one embodiment of the invention. The integrated circuit device 500 shown in FIG. 1A includes a memory block MB (display data RAM) and a data driver block DB. The memory block MB and the data driver block DB are disposed along a direction D2. The memory block MB and the data driver block DB are ultra-flat blocks of which the length along a direction D1 is longer than the width in the direction D2.

Image data supplied from a host is written into the memory block MB. The data driver block DB converts the digital image data written into the memory block MB into an analog data voltage, and drives data lines of a display panel. In FIG. 1A, the image data signal flows in the direction D2. Therefore, in the comparative example shown in FIG. 1A, the memory block MB and the data driver block DB are disposed along the direction D2 corresponding to the signal flow. This reduces the path between the input and the output so that a signal delay can be optimized, whereby an efficient signal transmission can be achieved.

However, the comparative example shown in FIG. 1A has the following problems.

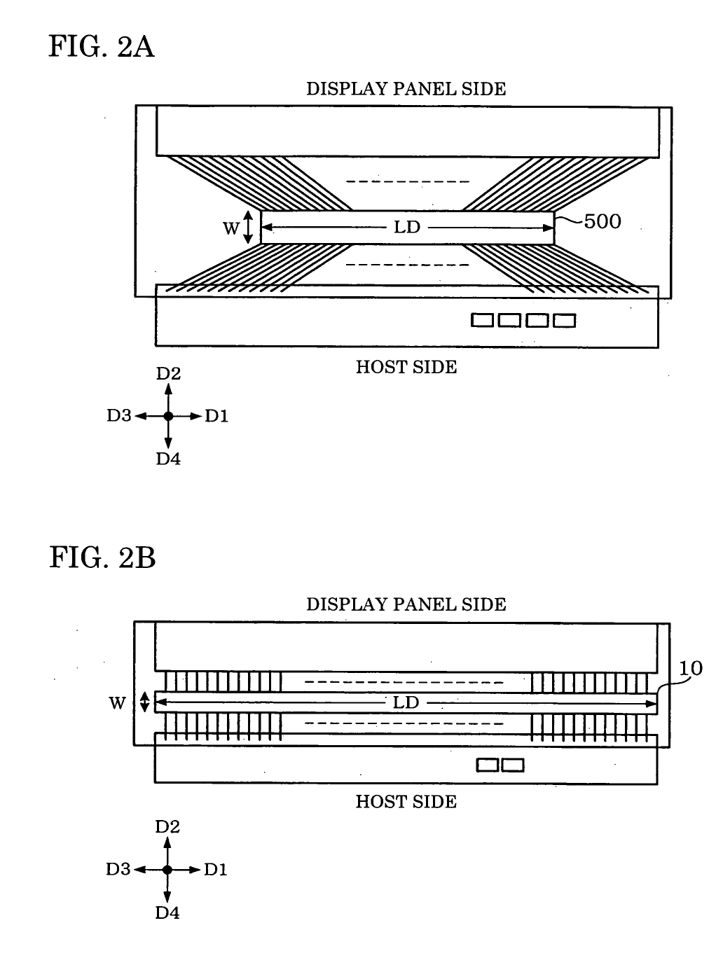

First, a reduction in the chip size is required for an integrated circuit device such as a display driver in order to reduce cost. However, if the chip size is reduced by merely shrinking the integrated circuit device 500 by using a microfabrication technology, the size of the integrated circuit device 500 is reduced not only in the short side direction but also in the long side direction. Therefore, it becomes difficult to mount the integrated circuit device 500 as shown in FIG. 2A. Specifically, it is desirable that the output pitch be 22 μm or more, for example. However, the output pitch is reduced to 17 μm by merely shrinking the integrated circuit device 500 as shown in FIG. 2A, for example, whereby it becomes difficult to mount the integrated circuit device 500 due to the narrow pitch. Moreover, the number of glass substrates obtained is decreased due to an increase in the glass frame of the display panel, whereby cost is increased.

Second, the configurations of the memory and the data driver of the display driver are changed corresponding to the type of display panel (amorphous TFT or low-temperature polysilicon TFT), the number of pixels (QCIF, QVGA, or VGA), the specification of the product, and the like. Therefore, in the comparative example shown in FIG. 1A, even if the pad pitch, the cell pitch of the memory, and the cell pitch of the data driver coincide in one product as shown in FIG. 1B, the pitches do not coincide as shown in FIG. 1C when the configurations of the memory and the data driver are changed. If the pitches do not coincide as shown in FIG. 1C, an unnecessary interconnect region for absorbing the pitch difference must be formed between the circuit blocks. In particular, in the comparative example shown in FIG. 1A in which the block is made flat in the direction D1, the area of an unnecessary interconnect region for absorbing the pitch difference is increased. As a result, the width W of the integrated circuit device 500 in the direction D2 is increased, whereby cost is increased due to an increase in the chip area.

If the layout of the memory and the data driver is changed so that the pad pitch coincides with the cell pitch in order to avoid such a problem, the development period is increased, whereby cost is increased. Specifically, since the circuit configuration and the layout of each circuit block are individually designed and the pitch is adjusted thereafter in the comparative example shown in FIG. 1A, unnecessary area is provided or the design becomes inefficient.

2. Configuration of Integrated Circuit Device

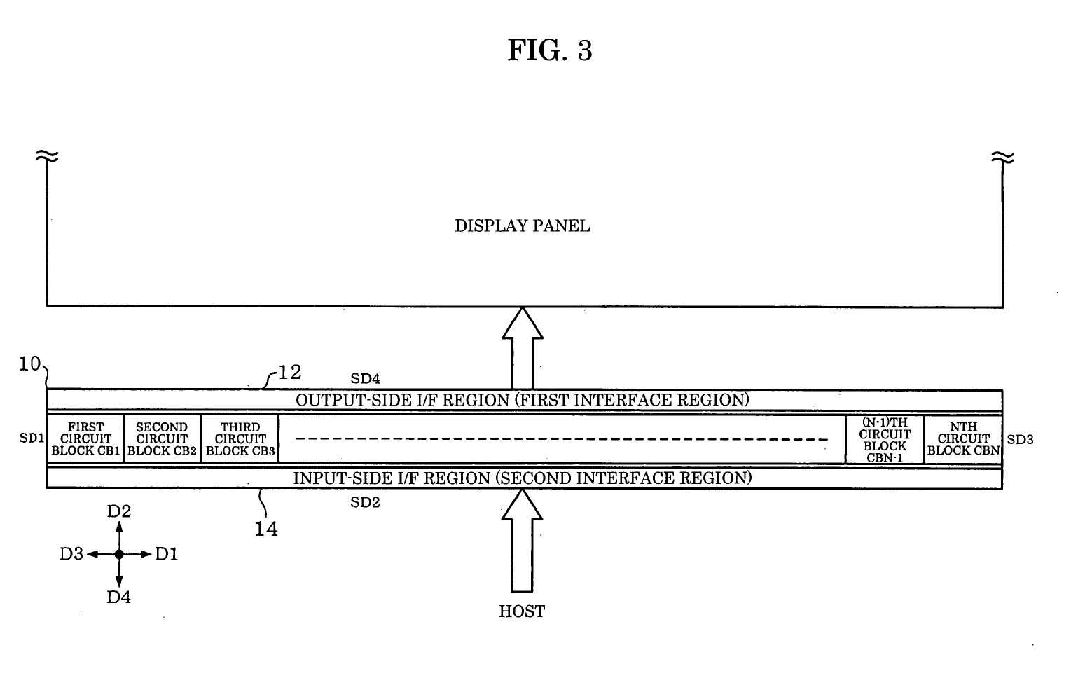

FIG. 3 shows a configuration example of an integrated circuit device 10 of one embodiment of the invention which can solve the above-described problems. In this embodiment, the direction from a first side SD1 (short side) of the integrated circuit device 10 toward a third side SD3 opposite to the first side SD1 is defined as a first direction D1, and the direction opposite to the first direction D1 is defined as a third direction D3. The direction from a second side SD2 (long side) of the integrated circuit device 10 toward a fourth side SD4 opposite to the second side SD2 is defined as a second direction D2, and the direction opposite to the second direction D2 is defined as a fourth direction D4. In FIG. 3, the left side of the integrated circuit device 10 is the first side SD1, and the right side is the third side SD3. However, the left side may be the third side SD3, and the right side may be the first side SD1.

As shown in FIG. 3, the integrated circuit device 10 according to this embodiment includes first to Nth circuit blocks CB1 to CBN (N is an integer larger than one) disposed along the direction D1. Specifically, while the circuit blocks are arranged in the direction D2 in the comparative example shown in FIG. 1A, the circuit blocks CB1 to CBN are arranged in the direction D1 In this embodiment. Each circuit block is a relatively square block differing from the ultra-flat block as in the comparative example shown in FIG. 1A.

The integrated circuit device 10 includes an output-side I/F region 12 (first interface region in a broad sense) provided along the side SD4 and on the D2 side of the first to Nth circuit blocks CB1 to CBN. The integrated circuit device 10 includes an input-side I/F region 14 (second interface region in a broad sense) provided along the side SD2 and on the D4 side of the first to Nth circuit blocks CB1 to CBN. In more detail, the output-side I/F region 12 (first I/O region) is disposed on the D2 side of the circuit blocks CB1 to CBN without other circuit blocks interposed therebetween, for example. The input-side I/F region 14 (second I/O region) is disposed on the D4 side of the circuit blocks CB1 to CBN without other circuit blocks interposed therebetween, for example. Specifically, only one circuit block (data driver block) exists in the direction D2 at least in the area in which the data driver block exists. When the integrated circuit device 10 is used as an intellectual property (IP) core and incorporated in another integrated circuit device, the integrated circuit device 10 may be configured to exclude at least one of the I/F regions 12 and 14.

The output-side (display panel side) I/F region 12 is a region which serves as an interface between the integrated circuit device 10 and the display panel, and includes pads and various elements such as output transistors and protective elements connected with the pads. In more detail, the output-side I/F region 12 includes output transistors for outputting data signals to data lines and scan signals to scan lines, for example. When the display panel is a touch panel, the output-side I/F region 12 may include input transistors.

The input-side I/F region 14 is a region which serves as an interface between the integrated circuit device 10 and a host (MPU, image processing controller, or baseband engine), and may include pads and various elements connected with the pads, such as input (input-output) transistors, output transistors, and protective elements. In more detail, the input-side I/F region 14 includes input transistors for inputting signals (digital signals) from the host, output transistors for outputting signals to the host, and the like.

An output-side or input-side I/F region may be provided along the short side SD1 or SD3. Bumps which serve as external connection terminals may be provided in the I/F (interface) regions 12 and 14, or may be provided in other regions (first to Nth circuit blocks CB1 to CBN). When providing the bumps in the region other than the I/F regions 12 and 14, the bumps are formed by using a small bump technology (e.g. bump technology using resin core) other than a gold bump technology.

The first to Nth circuit blocks CB1 to CBN may include at least two (or three) different circuit blocks (circuit blocks having different functions). Taking an example in which the integrated circuit device 10 is a display driver, the circuit blocks CB1 to CBN may include at least two of a data driver block, a memory block, a scan driver block, a logic circuit block, a grayscale voltage generation circuit block, and a power supply circuit block. In more detail, the circuit blocks CB1 to CBN may include at least a data driver block and a logic circuit block, and may further include a grayscale voltage generation circuit block. When the integrated circuit device 10 includes a built-in memory, the circuit blocks CB1 to CBN may further include a memory block.

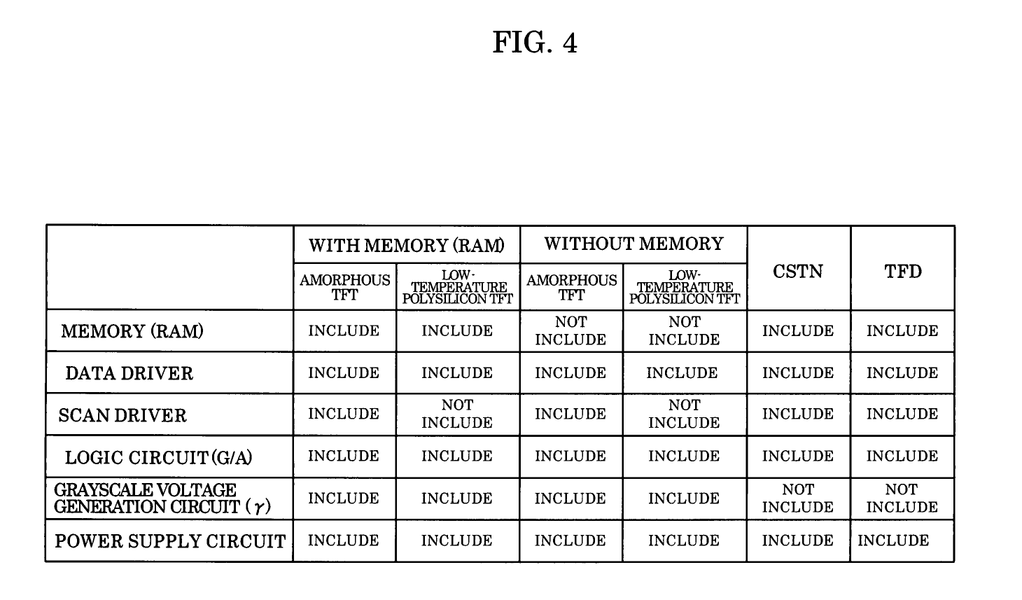

FIG. 4 shows an example of various types of display drivers and circuit blocks provided in the display drivers. In an amorphous thin film transistor (TFT) panel display driver including a built-in memory (RAM), the circuit blocks CB1 to CBN include a memory block, a data driver (source driver) block, a scan driver (gate driver) block, a logic circuit (gate array circuit) block, a grayscale voltage generation circuit (γ-correction circuit) block, and a power supply circuit block. In a low-temperature polysilicon (LTPS) TFT panel display driver including a built-in memory, since the scan driver can be formed on a glass substrate, the scan driver block may be omitted. The memory block may be omitted in an amorphous TFT panel display driver which does not include a memory, and the memory block and the scan driver block may be omitted in a low-temperature polysilicon TFT panel display driver which does not include a memory. In a color super twisted nematic (CSTN) panel display driver and a thin film diode (TFD) panel display driver, the grayscale voltage generation circuit block may be omitted.

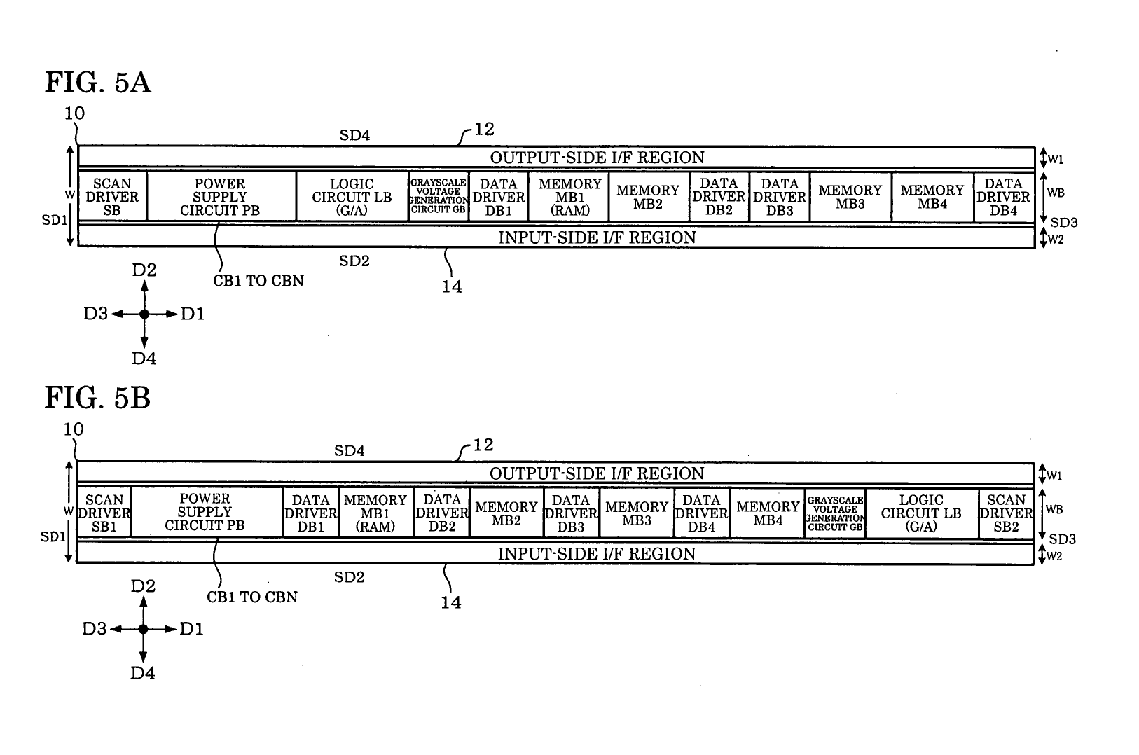

FIGS. 5A and 5B show examples of a planar layout of the integrated circuit device 10 as the display driver according to this embodiment. FIGS. 5A and 5B are examples of an amorphous TFT panel display driver including a built-in memory. FIG. 5A shows a QCIF and 32-grayscale display driver, and FIG. 5B shows a QVGA and 64-grayscale display driver.

In FIGS. 5A and 5B, the first to Nth circuit blocks CB1 to CBN include first to fourth memory blocks MB1 to MB4 (first to Ith memory blocks in a broad sense; I is an integer larger than one). The first to Nth circuit blocks CB1 to CBN include first to fourth data driver blocks DB1 to DB4 (first to Ith data driver blocks in a broad sense) respectively disposed adjacent to the first to fourth memory blocks MB1 to MB4 along the direction D1. In more detail, the memory block MB1 and the data driver block DB1 are disposed adjacent to each other along the direction D1, and the memory block MB2 and the data driver block DB2 are disposed adjacent to each other along the direction D1. The memory block MB1 adjacent to the data driver block DB1 stores image data (display data) used by the data driver block DB1 to drive the data line, and the memory block MB2 adjacent to the data driver block DB2 stores image data used by the data driver block DB2 to drive the data line.

In FIG. 5A, the data driver block DB1 (Jth data driver block in a broad sense; 1≦J<I) of the data driver blocks DB1 to DB4 is disposed adjacently on the D3 side of the memory block MB1 (Jth memory block in a broad sense) of the memory blocks MB1 to MB4. The memory block MB2 ((J+1)th memory block in a broad sense) is disposed adjacently on the D1 side of the memory block MB1. The data driver block DB2 ((J+1)th data driver block in a broad sense) is disposed adjacently on the D1 side of the memory block MB2. The arrangement of the memory blocks MB3 and MB4 and the data driver blocks DB3 and DB4 is the same as described above. In FIG. 5A, the memory block MB1 and the data driver block DB1 and the memory block MB2 and the data driver block DB2 are disposed line-symmetrical with respect to the borderline between the memory blocks MB1 and MB2, and the memory block MB3 and the data driver block DB3 and the memory block MB4 and the data driver block DB4 are disposed line-symmetrical with respect to the borderline between the memory blocks MB3 and MB4. In FIG. 5A, the data driver blocks DB2 and DB3 are disposed adjacent to each other. However, another circuit block may be disposed between the data driver blocks DB2 and DB3.

In FIG. 5B, the data driver block DB1 (Jth data driver block) of the data driver blocks DB1 to DB4 is disposed adjacently on the D3 side of the memory block MB1 (Jth memory block) of the memory blocks MB1 to MB4. The data driver block DB2 ((J+1)th data driver block) is disposed on the D1 side of the memory block MB1. The memory block MB2 ((J+1)th memory block) is disposed on the D1 side of the data driver block DB2. The data driver block DB3, the memory block MB3, the data driver block DB4, and the memory block MB4 are disposed in the same manner as described above. In FIG. 5B, the memory block MB1 and the data driver block DB2, the memory block MB2 and the data driver block DB3, and the memory block MB3 and the data driver block DB4 are respectively disposed adjacent to each other. However, another circuit block may be disposed between these blocks.

The layout arrangement shown in FIG. 5A has an advantage in that a column address decoder can be used in common between the memory blocks MB1 and MB2 or the memory blocks MB3 and MB4 (between the Jth and (J+1)th memory blocks). The layout arrangement shown in FIG. 5B has an advantage in that the interconnect pitch of the data signal output lines from the data driver blocks DB1 to DB4 to the output-side I/F region 12 can be equalized so that the interconnect efficiency can be increased.

The layout arrangement of the integrated circuit device 10 according to this embodiment is not limited to those shown in FIGS. 5A and 5B. For example, the number of memory blocks and data driver blocks may be set at 2, 3, or 5 or more, or the memory block and the data driver block may not be divided into blocks. A modification in which the memory block is not disposed adjacent to the data driver block is also possible. A configuration is also possible in which the memory block, the scan driver block, the power supply circuit block, or the grayscale voltage generation circuit block is not provided. A circuit block having a width significantly small in the direction D2 (narrow circuit block having a width less than the width WB) may be provided between the circuit blocks CB1 to CBN and the output-side I/F region 12 or the input-side I/F region 14. The circuit blocks CB1 to CBN may include a circuit block in which different circuit blocks are arranged in stages in the direction D2. For example, the scan driver circuit and the power supply circuit may be formed in one circuit block.

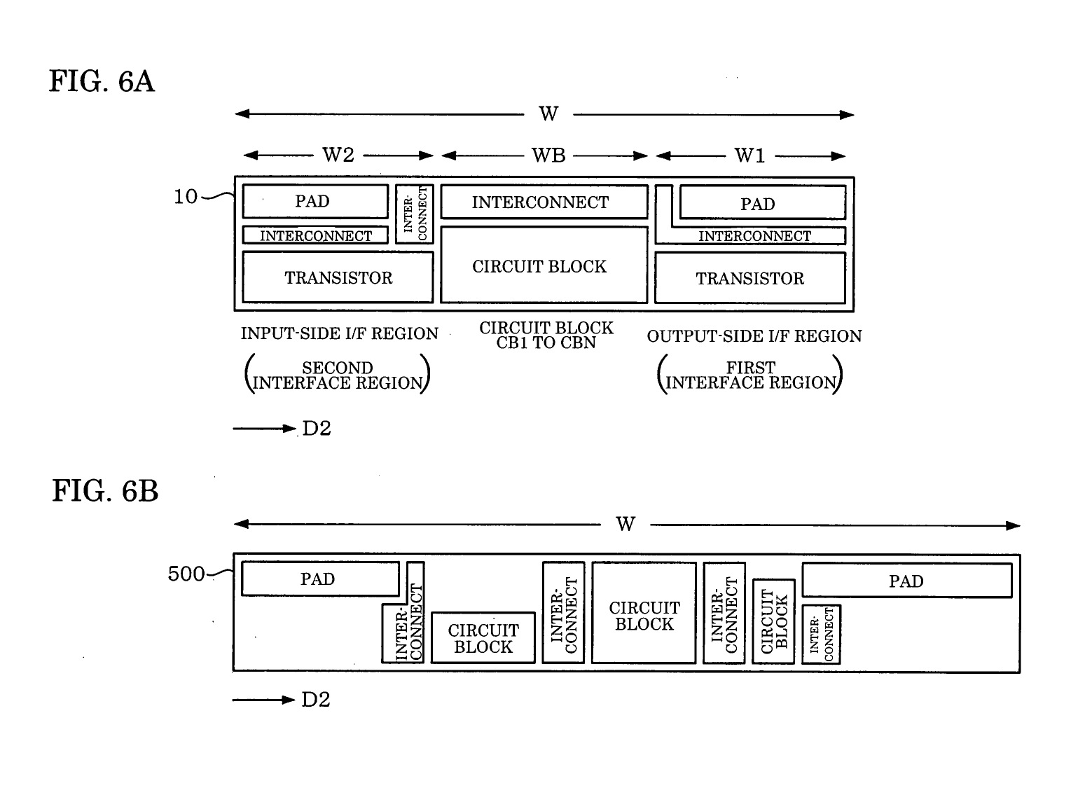

FIG. 6A shows an example of a cross-sectional view of the integrated circuit device 10 according to this embodiment along the direction D2. W1, WB, and W2 respectively indicate the widths of the output-side I/F region 12, the circuit blocks CB1 to CBN, and the input-side I/F region 14 in the direction D2. W indicates the width of the integrated circuit device 10 in the direction D2.

In this embodiment, as shown in FIG. 6A, a configuration may be employed in which a circuit blocks is not provided between the circuit blocks CB1 to CBN (data driver block DB) and the output-side I/F region 12 or input-side I/F region 14. Therefore, the relationship “W1+WB+W2≦W<W1+2×WB+W2” is satisfied so that a slim integrated circuit device can be realized. In more detail, the width W in the direction D2 may be set at “W<2 mm”. More specifically, the width W in the direction D2 may be set at “W<1.5 mm”. It is preferable that “W>0.9 mm” taking inspection and mounting of the chip into consideration. A length LD in the long side direction may be set at “15 mm<LD<27 mm”. A chip shape ratio SP (=LD/W) may be set at “SP>10”. More specifically, the chip shape ratio SP may be set at “SP>12”.

The widths W1, WB, and W2 shown in FIG. 6A indicate the widths of transistor formation regions (bulk regions or active regions) of the output-side I/F region 12, the circuit blocks CB1 to CBN, and the input-side I/F region 14, respectively. Specifically, output transistors, input transistors, input-output transistors, transistors of electrostatic protection elements, and the like are formed in the I/F regions 12 and 14. Transistors which form circuits are formed in the circuit blocks CB1 to CBN. The widths W1, WB, and W2 are determined based on well regions and diffusion regions by which such transistors are formed. In order to realize a slim integrated circuit device, it is preferable to form bumps (active surface bumps) on the transistors of the circuit blocks CB1 to CBN. In more detail, a resin core bump in which the core is formed of a resin and a metal layer is formed on the surface of the resin or the like is formed above the transistor (active region). These bumps (external connection terminals) are connected with the pads disposed in the I/F regions 12 and 14 through metal interconnects. The widths W1, WB, and W2 according to this embodiment are not the widths of the bump formation regions, but the widths of the transistor formation regions formed under the bumps.

The widths of the circuit blocks CB1 to CBN in the direction D2 may be identical, for example. In this case, it suffices that the width of each circuit block be substantially identical, and the width of each circuit block may differ in the range of several to 20 μm (several tens of microns), for example. When a circuit block with a different width exists in the circuit blocks CB1 to CBN, the width WB may be the maximum width of the circuit blocks CB1 to CBN. In this case, the maximum width may be the width of the data driver block in the direction D2, for example. In the case where the integrated circuit device includes a memory, the maximum width may be the width of the memory block in the direction D2. A vacant region having a width of about 20 to 30 μm may be provided between the circuit blocks CB1 to CBN and the I/F regions 12 and 14, for example.

In this embodiment, a pad of which the number of stages in the direction D2 is one or more may be disposed in the output-side I/F region 12. Therefore, the width W1 of the output-side I/F region 12 in the direction D2 may be set at “0.13 mm≦W1≦0.4 mm” taking the pad width (e.g. 0.1 mm) and the pad pitch into consideration. Since a pad of which the number of stages in the direction D2 is one can be disposed in the input-side I/F region 14, the width W2 of the input-side I/F region 14 may be set at “0.1 mm≦W2≦0.2 mm”. In order to realize a slim integrated circuit device, interconnects for logic signals from the logic circuit block, grayscale voltage signals from the grayscale voltage generation circuit block, and a power supply must be formed on the circuit blocks CB1 to CBN by using global interconnects. The total width of these interconnects is about 0.8 to 0.9 mm, for example. Therefore, the widths WB of the circuit blocks CB1 to CBN may be set at “0.65 mm≦WB≦1.2 mm” taking the total width of these interconnects into consideration.

Since “0.65 mm≦WB≦1.2 mm” is satisfied even if W1=0.4 mm and W2=0.2 mm, WB>W1+W2 is satisfied. When the widths W1, WB, and W2 are minimum values, W1=0.13 mm, WB=0.65 mm, and W2=0.1 mm so that the width W of the integrated circuit device is about 0.88 mm. Therefore, “W=0.88 mm<2×WB=1.3 mm” is satisfied. When the widths W1, WB, and W2 are maximum values, W1=0.4 mm, WB=1.2 mm, and W2=0.2 mm so that the width W of the integrated circuit device is about 1.8 mm. Therefore, “W=1.8 mm<2×WB=2.4 mm” is satisfied. Therefore, the relational equation “W<2×WB” is satisfied so that a slim integrated circuit device is realized.

In the comparative example shown in FIG. 1A, two or more circuit blocks are disposed along the direction D2 as shown in FIG. 6B. Moreover, interconnect regions are formed between the circuit blocks and between the circuit blocks and the I/F region in the direction D2. Therefore, since the width W of the integrated circuit device 500 in the direction D2 (short side direction) is increased, a slim chip cannot be realized. Therefore, even if the chip is shrunk by using a microfabrication technology, the length LD in the direction D1 (long side direction) is decreased, as shown in FIG. 2A, so that the output pitch becomes narrow, whereby it becomes difficult to mount the integrated circuit device 500.

In this embodiment, the circuit blocks CB1 to CBN are disposed along the direction D1 as shown in FIGS. 3, 5A, and 5B. As shown in FIG. 6A, the transistor (circuit element) can be disposed under the pad (bump) (active surface bump). Moreover, the signal lines can be formed between the circuit blocks and between the circuit blocks and the I/F by using the global interconnects formed in the upper layer (lower layer of the pad) of the local interconnects in the circuit blocks. Therefore, since the width W of the integrated circuit device 10 in the direction D2 can be reduced while maintaining the length LD of the integrated circuit device 10 in the direction D1 as shown in FIG. 2B, a very slim chip can be realized. As a result, since the output pitch can be maintained at 22 μm or more, for example, mounting can be facilitated.

In this embodiment, since the circuit blocks CB1 to CBN are disposed along the direction D1, it is possible to easily deal with a change in the product specifications and the like. Specifically, since product of various specifications can be designed by using a common platform, the design efficiency can be increased. For example, when the number of pixels or the number of grayscales of the display panel is increased or decreased in FIGS. 5A and 5B, it is possible to deal with such a situation merely by increasing or decreasing the number of blocks of memory blocks or data driver blocks, the number of readings of image data in one horizontal scan period, or the like. FIGS. 5A and 5B show an example of an amorphous TFT panel display driver including a memory. When developing a low-temperature polysilicon TFT panel product including a memory, it suffices to remove the scan driver block from the circuit blocks CB1 to CBN. When developing a product which does not include a memory, it suffices to remove the memory block from the circuit blocks CB1 to CBN. In this embodiment, even if the circuit block is removed corresponding to the specification, since the effect on the remaining circuit blocks is minimized, the design efficiency can be increased.

In this embodiment, the widths (heights) of the circuit blocks CB1 to CBN in the direction D2 can be uniformly adjusted to the width (height) of the data driver block or the memory block, for example. Since it is possible to deal with an increase or decrease in the number of transistors of each circuit block by increasing or decreasing the length of each circuit block in the direction D1, the design efficiency can be further increased. For example, when the number of transistors is increased or decreased in FIGS. 5A and 5B due to a change in the configuration of the grayscale voltage generation circuit block or the power supply circuit block, it is possible to deal with such a situation by increasing or decreasing the length of the grayscale voltage generation circuit block or the power supply circuit block in the direction D1.

As a second comparative example, a narrow data driver block may be disposed in the direction D1, and other circuit blocks such as the memory block may be disposed along the direction D1 on the D4 side of the data driver block, for example. However, in the second comparative example, since the data driver block having a large width lies between other circuit blocks such as the memory block and the output-side I/F region, the width W of the integrated circuit device in the direction D2 is increased, so that it is difficult to realize a slim chip. Moreover, an additional interconnect region is formed between the data driver block and the memory block, whereby the width W is further increased. Furthermore, when the configuration of the data driver block or the memory block is changed, the pitch difference described with reference to FIGS. 1B and 1C occurs, whereby the design efficiency cannot be increased.

As a third comparative example of this embodiment, only circuit blocks (e.g. data driver blocks) having the same function may be divided and arranged in the direction D1. However, since the integrated circuit device can be provided with only a single function (e.g. function of the data driver) in the third comparative example, development of various products cannot be realized. In this embodiment, the circuit blocks CB1 to CBN include circuit blocks having at least two different functions. Therefore, various integrated circuit devices corresponding to various types of display panels can be provided as shown in FIGS. 4, 5A, and 5B.

3. Circuit Configuration

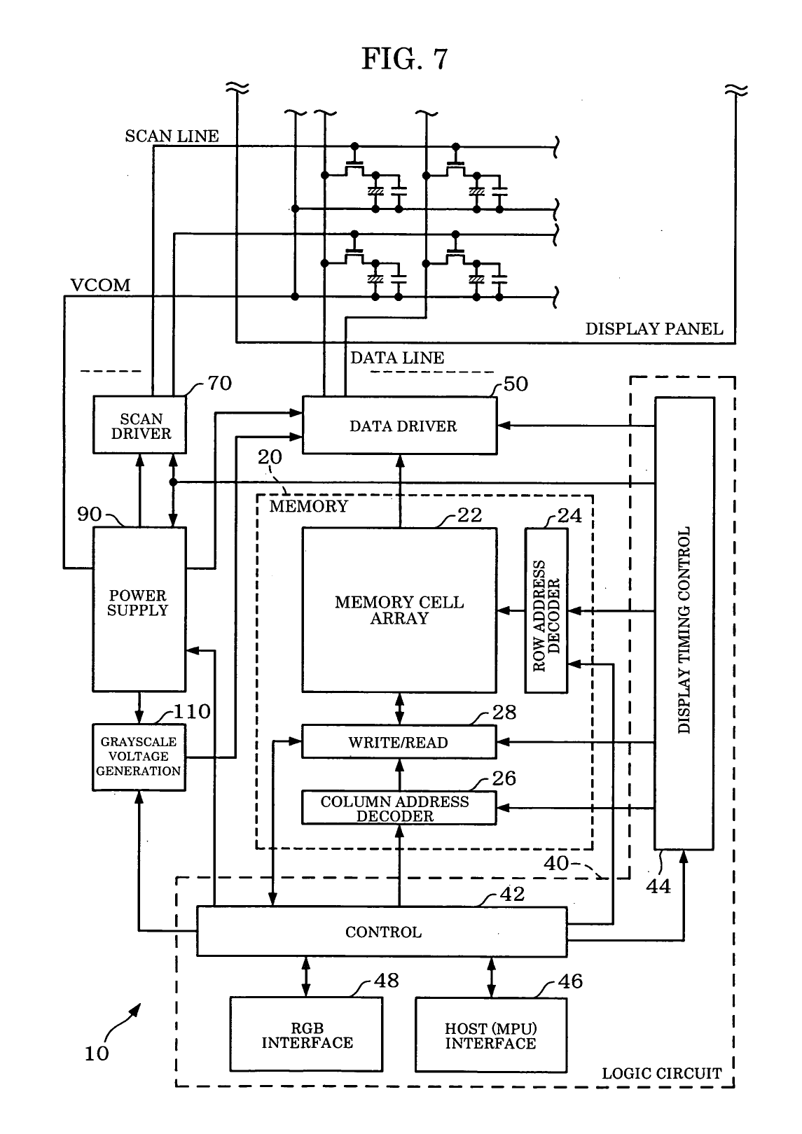

FIG. 7 shows a circuit configuration example of the integrated circuit device 10. The circuit configuration of the integrated circuit device 10 is not limited to the circuit configuration shown in FIG. 7. Various modifications and variations may be made. A memory 20 (display data RAM) stores image data. A memory cell array 22 includes a plurality of memory cells, and stores image data (display data) for at least one frame (one screen). In this case, one pixel is made up of R, G, and B subpixels (three dots), and 6-bit (k-bit) image data is stored for each subpixel, for example. A row address decoder 24 (MPU/LCD row address decoder) decodes a row address and selects a wordline of the memory cell array 22. A column address decoder 26 (MPU column address decoder) decodes a column address and selects a bitline of the memory cell array 22. A write/read circuit 28 (MPU write/read circuit) writes image data into the memory cell array 22 or reads image data from the memory cell array 22. An access region of the memory cell array 22 is defined by a rectangle having a start address and an end address as opposite vertices. Specifically, the access region is defined by the column address and the row address of the start address and the column address and the row address of the end address so that memory access is performed.

A logic circuit 40 (e.g. automatic placement and routing circuit) generates a control signal for controlling display timing, a control signal for controlling data processing timing, and the like. The logic circuit 40 may be formed by automatic placement and routing such as a gate array (G/A). A control circuit 42 generates various control signals and controls the entire device. In more detail, the control circuit 42 outputs grayscale characteristic (γ-characteristic) adjustment data (γ-correction data) to a grayscale voltage generation circuit 110 and controls voltage generation of a power supply circuit 90. The control circuit 42 controls write/read processing for the memory using the row address decoder 24, the column address decoder 26, and the write/read circuit 28. A display timing control circuit 44 generates various control signals for controlling display timing, and controls reading of image data from the memory into the display panel. A host (MPU) interface circuit 46 realizes a host interface which accesses the memory by generating an internal pulse each time accessed by the host. An RGB interface circuit 48 realizes an RGB interface which writes motion picture RGB data into the memory based on a dot clock signal. The integrated circuit device 10 may be configured to include only one of the host interface circuit 46 and the RGB interface circuit 48.

In FIG. 7, the host interface circuit 46 and the RGB interface circuit 48 access the memory 20 in pixel units. Image data designated by a line address and read in line units is supplied to a data driver 50 in line cycle at an internal display timing independent of the host interface circuit 46 and the RGB interface circuit 48.

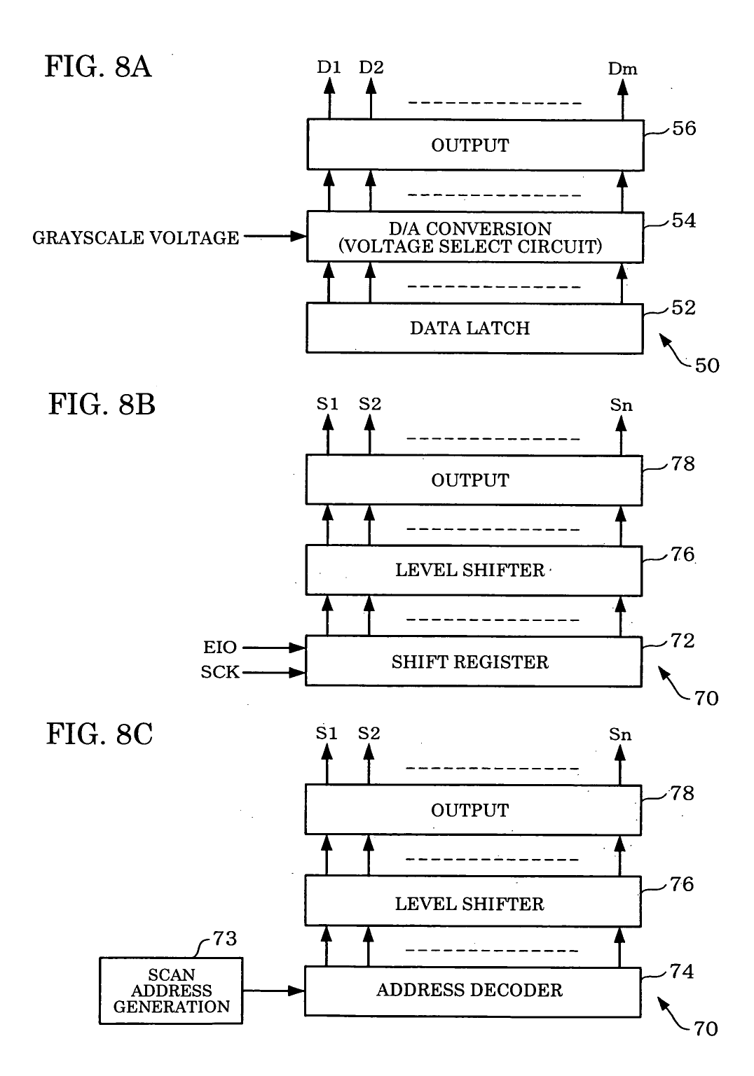

The data driver 50 is a circuit for driving a data line of the display panel. FIG. 8A shows a configuration example of the data driver 50. A data latch circuit 52 latches the digital image data from the memory 20. A D/A conversion circuit 54 (voltage select circuit) performs D/A conversion of the digital image data latched by the data latch circuit 52, and generates an analog data voltage. In more detail, the D/A conversion circuit 54 receives a plurality of (e.g. 64 stages) grayscale voltages (reference voltages) from the grayscale voltage generation circuit 110, selects a voltage corresponding to the digital image data from the grayscale voltages, and outputs the selected voltage as the data voltage. An output circuit 56 (driver circuit or buffer circuit) buffers the data voltage from the D/A conversion circuit 54, and outputs the data voltage to the data line of the display panel to drive the data line. A part of the output circuit 56 (e.g. output stage of operational amplifier) may not be included in the data driver 50 and may be disposed in other region.

A scan driver 70 is a circuit for driving a scan line of the display panel. FIG. 8B shows a configuration example of the scan driver 70. A shift register 72 includes a plurality of sequentially connected flip-flops, and sequentially shifts an enable input-output signal EIO in synchronization with a shift clock signal SCK. A level shifter 76 converts the voltage level of the signal from the shift register 72 into a high voltage level for selecting the scan line. An output circuit 78 buffers a scan voltage converted and output by the level shifter 76, and outputs the scan voltage to the scan line of the display panel to drive the scan line. The scan driver 70 may be configured as shown in FIG. 8C. In FIG. 8C, a scan address generation circuit 73 generates and outputs a scan address, and an address decoder decodes the scan address. The scan voltage is output to the scan line specified by the decode processing through the level shifter 76 and the output circuit 78.

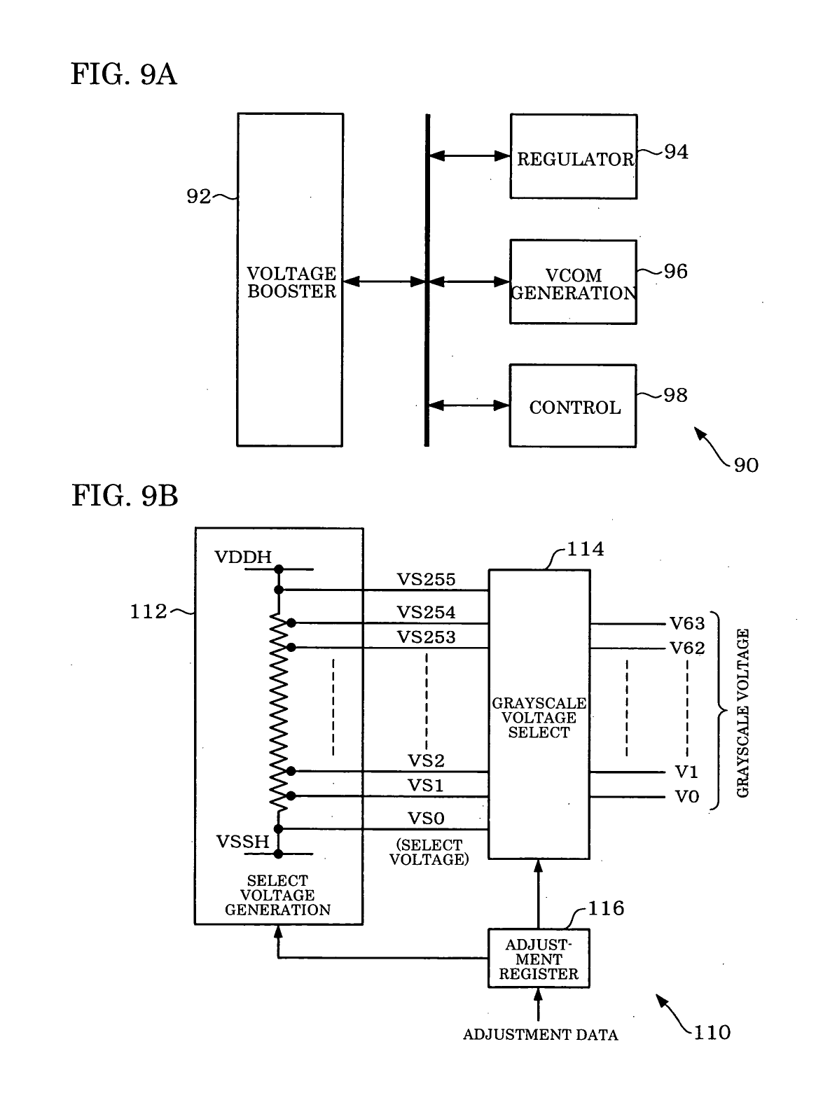

The power supply circuit 90 is a circuit which generates various power supply voltages. FIG. 9A shows a configuration example of the power supply circuit 90. A voltage booster circuit 92 is a circuit which generates a boosted voltage by boosting an input power source voltage or an internal power supply voltage by a charge-pump method using a boost capacitor and a boost transistor, and may include first to fourth voltage booster circuits and the like. A high voltage used by the scan driver 70 and the grayscale voltage generation circuit 110 can be generated by the voltage booster circuit 92. A regulator circuit 94 regulates the level of the boosted voltage generated by the voltage booster circuit 92. A VCOM generation circuit 96 generates and outputs a voltage VCOM supplied to a common electrode of the display panel. A control circuit 98 controls the power supply circuit 90, and includes various control registers and the like.

The grayscale voltage generation circuit 110 (γ-correction circuit) is a circuit which generates grayscale voltages. FIG. 9B shows a configuration example of the grayscale voltage generation circuit 110. A select voltage generation circuit 112 (voltage divider circuit) outputs select voltages VS0 to VS255 (R select voltages in a broad sense) based on high-voltage power supply voltages VDDH and VSSH generated by the power supply circuit 90. In more detail, the select voltage generation circuit 112 includes a ladder resistor circuit including a plurality of resistor elements connected in series. The select voltage generation circuit 112 outputs voltages obtained by dividing the power supply voltages VDDH and VSSH using the ladder resistor circuit as the select voltages VS0 to VS255. A grayscale voltage select circuit 114 selects 64 (S in a broad sense; R>S) voltages from the select voltages VS0 to VS255 in the case of using 64 grayscales based on the grayscale characteristic adjustment data set in an adjustment register 116 by the logic circuit 40, and outputs the selected voltages as grayscale voltages V0 to V63. This enables generation of a grayscale voltage having grayscale characteristics (γ-correction characteristics) optimum for the display panel. In the case of performing a polarity reversal drive, a positive ladder resistor circuit and a negative ladder resistor circuit may be provided in the select voltage generation circuit 112. The resistance value of each resistor element of the ladder resistor circuit may be changed based on the adjustment data set in the adjustment register 116. An impedance conversion circuit (voltage-follower-connected operational amplifier) may be provided in the select voltage generation circuit 112 or the grayscale voltage select circuit 114.

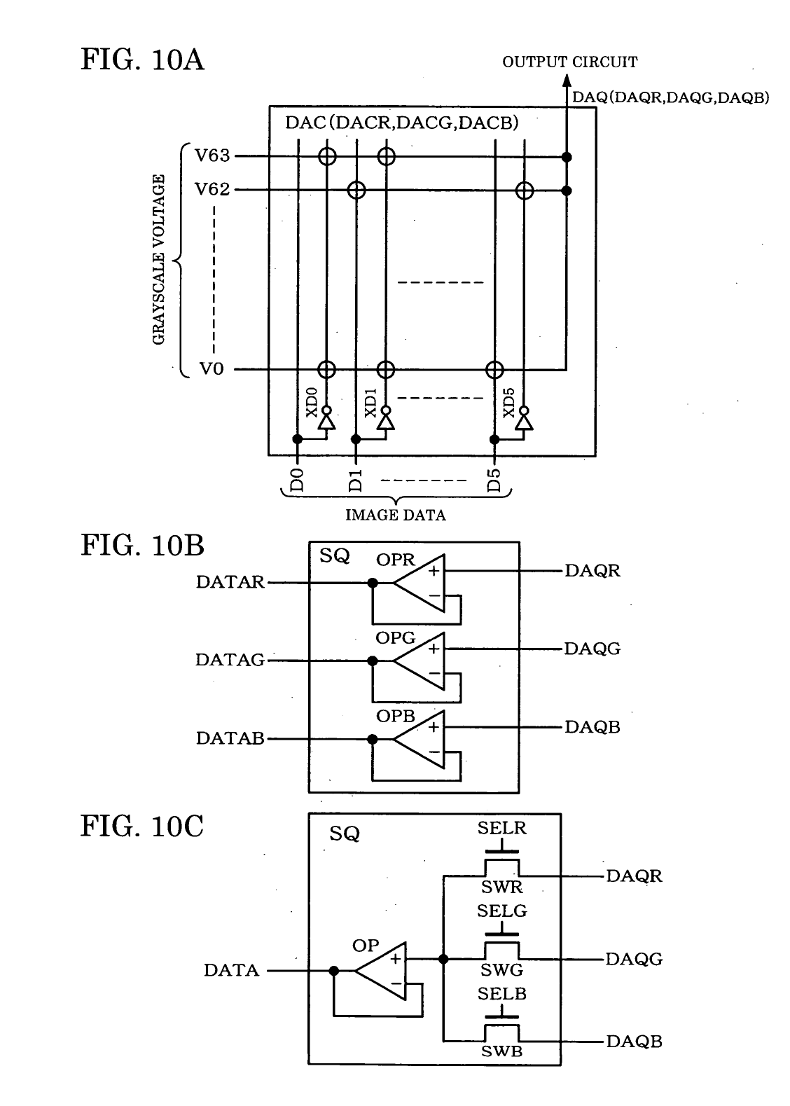

FIG. 10A shows a configuration example of a digital-analog converter (DAC) included in the D/A conversion circuit 54 shown in FIG. 8A. The DAC shown in FIG. 10A may be provided in subpixel units (or pixel units), and may be formed by a ROM decoder and the like. The DAC selects one of the grayscale voltages V0 to V63 from the grayscale voltage generation circuit 110 based on 6-bit digital image data D0 to D5 and inverted data XD0 to XD5 from the memory 20 to convert the image data D0 to D5 into an analog voltage. The DAC outputs the resulting analog voltage signal DAQ (DAQR, DAQG, DAQB) to the output circuit 56.

When R, G, and B data signals are multiplexed and supplied to a low-temperature polysilicon TFT display driver or the like (FIG. 10C), R, G, and B image data may be D/A converted by using one common DAC. In this case, the DAC shown in FIG. 10A is provided in pixel units.

FIG. 10B shows a configuration example of an output section SQ included in the output circuit 56 shown in FIG. 8A. The output section SQ shown in FIG. 10B may be provided in pixel units. The output section SQ includes R (red), G (green), and B (blue) impedance conversion circuits OPR, OPG, and OPB (voltage-follower-connected operational amplifiers), performs impedance conversion of the signals DAQR, DAQG, and DAQB from the DAC, and outputs data signals DATAR, DATAG, and DATAB to R, G, and B data signal output lines. When using a low-temperature polysilicon TFT panel, switch elements (switch transistors) SWR, SWG, and SWB as shown in FIG. 10C may be provided, and the impedance conversion circuit OP may output a data signal DATA in which the R, G, and B data signals are multiplexed. The data signals may be multiplexed over a plurality of pixels. Only the switch elements and the like may be provided in the output section SQ without providing the impedance conversion circuit as shown in FIGS. 10B and 10C.

4. Details of Data Driver Block and Memory Block

4.1 Block Division

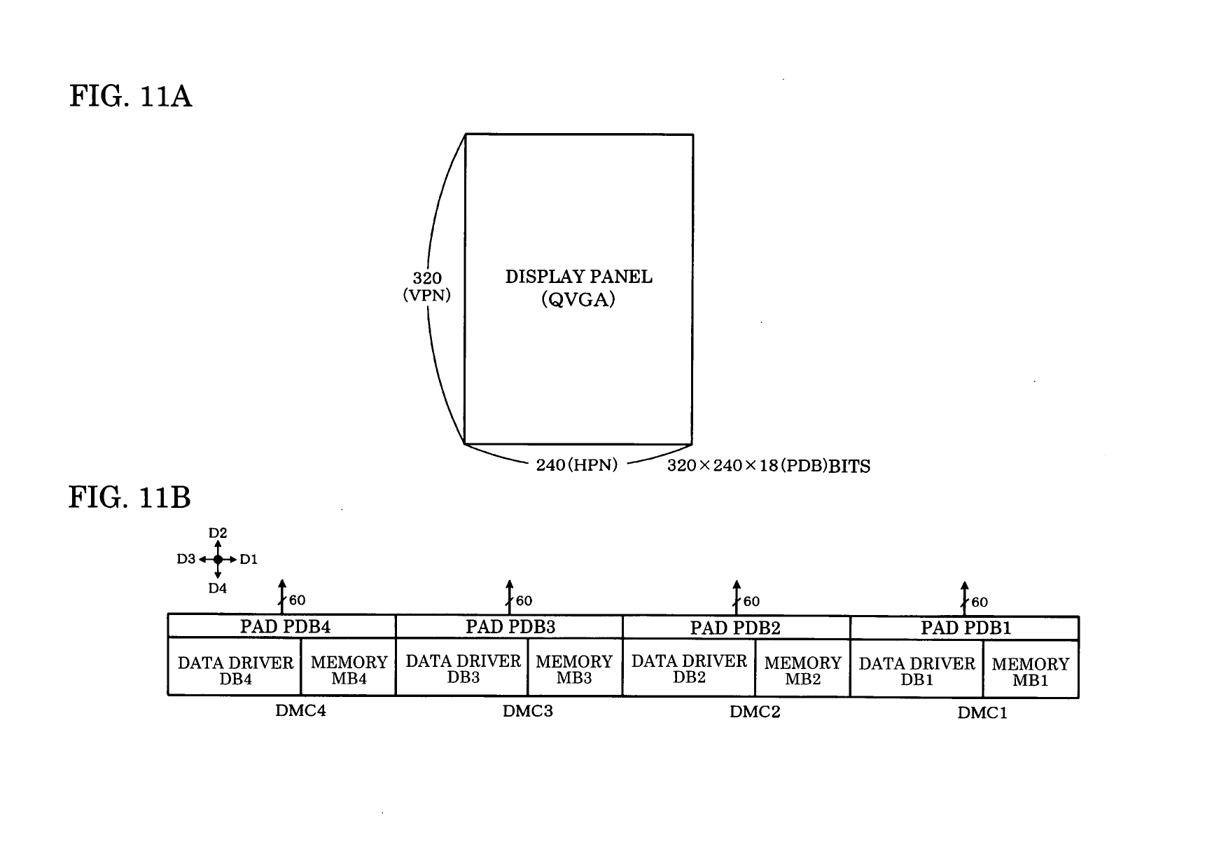

Consider the case where the display panel is a QVGA panel in which the number of pixels VPN in the vertical scan direction (data line direction) is 320 and the number of pixels HPN in the horizontal scan direction (scan line direction) is 240, as shown in FIG. 11A. Suppose that the number of bits PDB of image (display) data of one pixel is 18 bits (six bits each for R, G, and B). In this case, the number of bits of image data required to display one frame on the display panel is “VPN×HPN×PDB=320×240×18” bits. Therefore, the memory of the integrated circuit device stores at least “320×240×18” bits of image data. The data driver outputs data signals for 240 (=HPN) data lines (data signals corresponding to “240×18” bits of image data) to the display panel in units of horizontal scan periods (in units of periods in which one scan line is scanned).

In FIG. 11B, the data driver is divided into four (=DBN) data driver blocks DB1 to DB4. The memory is also divided into four (=MBN=DBN) memory blocks MB1 to MB4. Specifically, four driver macrocells DMC1, DMC2, DMC3, and DMC4, each of which includes the data driver block, the memory block, and the pad block integrated into a macrocell, are disposed along the direction D1, for example. Therefore, each of the data driver blocks DB1 to DB4 outputs data signals for 60 (=HPN/DBN=240/4) data lines to the display panel in units of horizontal scan periods. Each of the memory blocks MB1 to MB4 stores “(VPN×HPN×PDB)/MBN=(320×240×18)/4” bits of image data.

4.2 Plurality of Read Operations in One Horizontal Scan Period

In FIG. 11B, each of the data driver blocks DB1 to DB4 outputs data signals for 60 data lines (“60×3=180” data lines when three data lines are provided for R, G, and B) in one horizontal scan period. Therefore, image data corresponding to data signals for 240 data lines must be read from the data driver blocks DB1 to DB4 corresponding to the data driver blocks DB1 to DB4 in units of horizontal scan periods.

However, when the number of bits of image data read in units of horizontal scan periods is increased, it is necessary to increase the number of memory cells (sense amplifiers) arranged in the direction D2. As a result, the width W of the integrated circuit device is increased in the direction D2 to hinder a reduction in the width of the chip. Moreover, the length of the wordline WL is increased, whereby a signal delay occurs in the wordline WL.

In this embodiment, image data stored in the memory blocks MB1 to MB4 is read from the memory blocks MB1 to MB4 into the data driver blocks DB1 to DB4 a plurality of times (RN times) in one horizontal scan period.

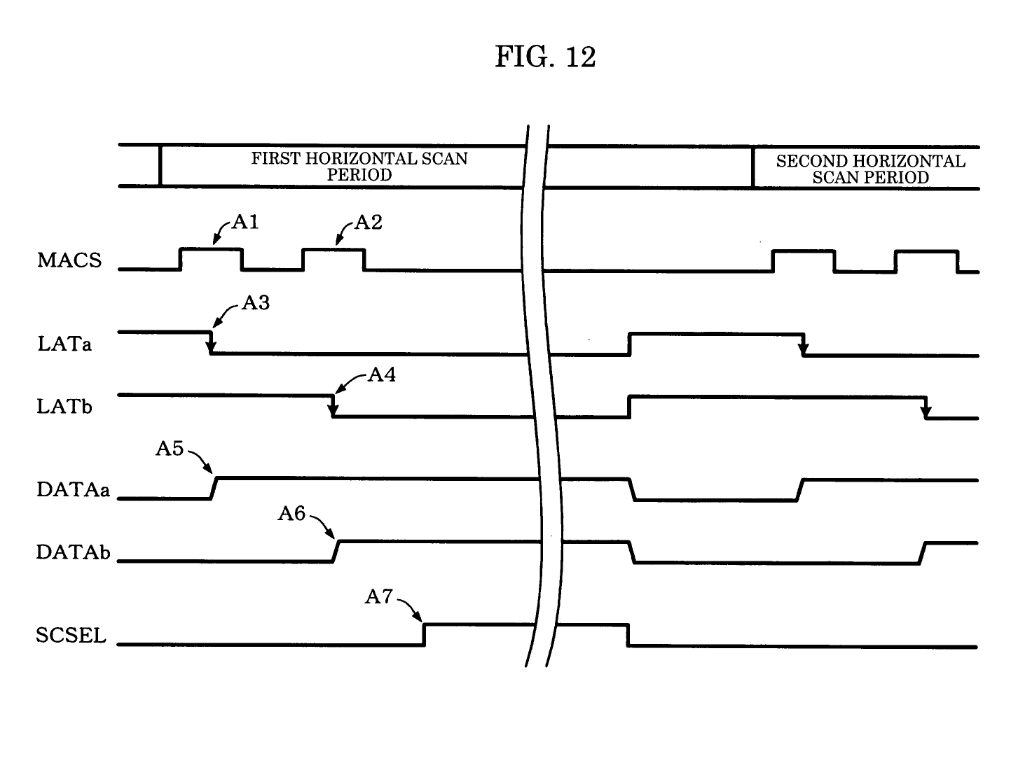

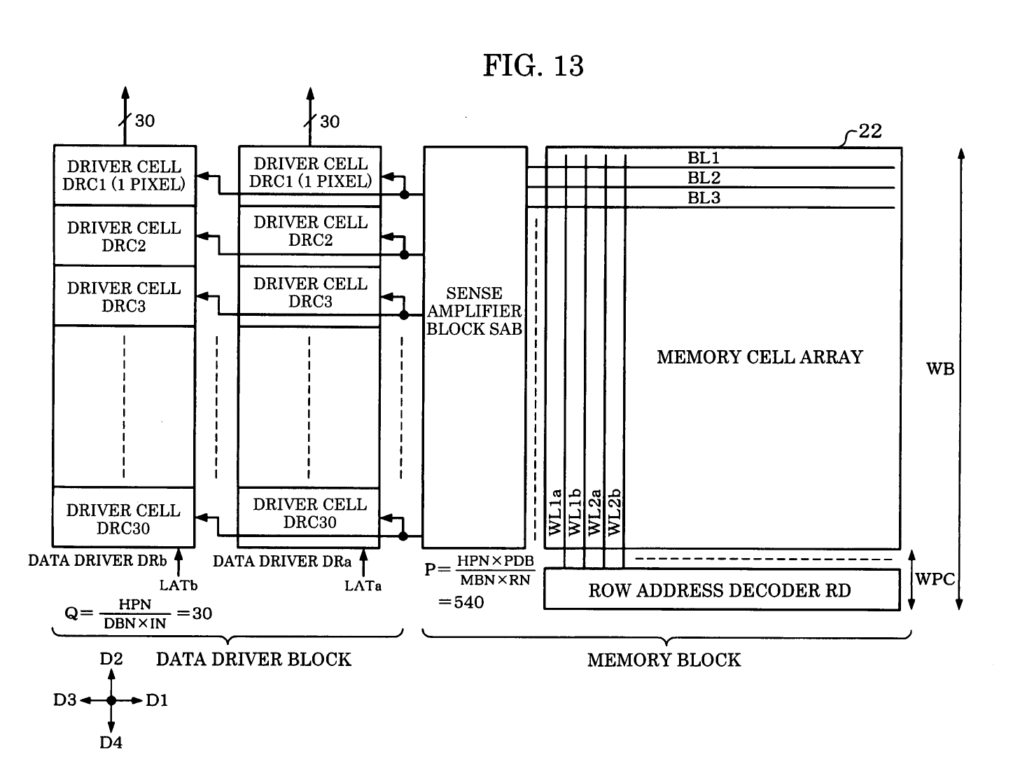

In FIG. 12, a memory access signal MACS (word select signal) goes active (high level) twice (RN=2) in one horizontal scan period, as indicated by A1 and A2, for example. This allows image data to be read from each memory block into each data driver block twice (RN=2) in one horizontal scan period. Then, data latch circuits included in data drivers DRa and DRb shown in FIG. 13 provided in the data driver block latch the image data read from the memory block based on latch signals LATa and LATb indicated by A3 and A4. D/A conversion circuits included in the data drivers DRa and DRb perform D/A conversion of the latched image data, and output circuits included in the data drivers DRa and DRb output data signals DATAa and DATAb obtained by D/A conversion to the data signal output lines, as indicated by A5 and A6. A scan signal SCSEL input to the gate of the TFT of each pixel of the display panel then goes active, as indicated by A7, and the data signal is input to and held in each pixel of the display panel.

In FIG. 12, the image data is read twice in the first horizontal scan period, and the data signals DATAa and DATAb are output to the data signal output lines in the first horizontal scan period. Note that the image data may be read twice and latched in the first horizontal scan period, and the data signals DATAa and DATAb corresponding to the latched image data may be output to the data signal output lines in the subsequent second horizontal scan period. FIG. 12 illustrates the case where the number RN of read operations is two. Note that the number RN may be three or more (RN≧3).

According to the method shown in FIG. 12, the image data corresponding to the data signals for 30 data lines is read from each memory block, and each of the data drivers DRa and DRb outputs the data signals for 30 data lines, as shown in FIG. 13. Therefore, the data signals for 60 data lines are output from each data driver block. In FIG. 13, it suffices to read the image data corresponding to the data signals for 30 data lines from each memory block in one read operation, as described above. Therefore, the number of memory cells and sense amplifiers in the direction D2 can be reduced in FIG. 13 in comparison with a method in which the image data is read only once in one horizontal scan period. As a result, the width of the integrated circuit device in the direction D2 can be reduced, whereby a very narrow chip can be realized. In a QVGA display, the length of one horizontal scan period is about 52 microseconds. On the other hand, the memory read time is about 40 nanoseconds, which is sufficiently shorter than 52 microseconds. Therefore, even if the number of read operations in one horizontal scan period is increased from one to two or more, the display characteristics are not affected to a large extent.

In addition to the QVGA (320×240) display panel shown in FIG. 11A, it is also possible to deal with a VGA (640×480) display panel by increasing the number of read operations in one horizontal scan period to four (RN=4), for example, whereby the degrees of freedom of the design can be increased.

A plurality of read operations in one horizontal scan period may be implemented using a first method in which the row address decoder (wordline select circuit) selects different wordlines in each memory block in one horizontal scan period, or a second method in which the row address decoder (wordline select circuit) selects a single wordline in each memory block a plurality of times in one horizontal scan period. Or, a plurality of read operations in one horizontal scan period may be implemented by combining the first method and the second method.

4.3 Arrangement of Data Driver and Driver Cell

FIG. 13 shows an arrangement example of data drivers and driver cells included in the data drivers. As shown in FIG. 13, the data driver block includes data drivers DRa and DRb (first to mth data drivers) arranged along the direction D1. Each of the data drivers DRa and DRb includes 30 (Q in a broad sense) driver cells DRC1 to DRC30.

When the wordline WL1a of the memory block has been selected and the first image data has been read from the memory block, as indicated by A1 in FIG. 12, the data driver DRa latches the read image data based on the latch signal LATa indicated by A3. The data driver DRa performs D/A conversion of the latched image data, and outputs the data signal DATAa corresponding to the first image data to the data signal output line, as indicated by A5.

When the wordline WL1b of the memory block has been selected and the second image data has been read from the memory block, as indicated by A2 in FIG. 12, the data driver DRb latches the read image data based on the latch signal LATb indicated by A4. The data driver DRb performs D/A conversion of the latched image data, and outputs the data signal DATAb corresponding to the second image data to the data signal output line, as indicated by A6.

Each of the data drivers DRa and DRb outputs data signals for 30 data lines corresponding to 30 pixels, whereby the data signals for 60 data lines corresponding to 60 pixels are output in total.

A problem in which the width W of the integrated circuit device in the direction D2 is increased due to an increase in the size of the data driver can be prevented by disposing (stacking) the data drivers DRa and DRb along the direction D1, as shown in FIG. 13. The data driver is configured in various ways depending on the type of display panel. In this case, data drivers having various configurations can be efficiently arranged by disposing the data drivers along the direction D1. FIG. 13 illustrates the case where the number of data drivers disposed along the direction D1 is two. Note that the number of data drivers disposed along the direction D1 may be three or more.

In FIG. 13, each of the data drivers DRa and DRb includes 30 (Q) driver cells DRC1 to DRC30 arranged along the direction D2. Each of the driver cells DRC1 to DRC30 receives image data of one pixel. Each of the driver cells DRC1 to DRCQ performs D/A conversion of the image data of one pixel, and outputs a data signal corresponding to the image data of one pixel. Each of the driver cells DRC1 to DRC30 may include a data latch circuit, the DAC (DAC for one pixel) shown in FIG. 10A, and the output section SQ shown in FIGS. 10B and 10C.

In FIG. 13, suppose that the number of pixels of the display panel in the horizontal scan direction (the number of pixels in the horizontal scan direction driven by each integrated circuit device when two or more integrated circuit devices cooperate to drive the data lines of the display panel) is HPN, the number of data driver blocks (number of block divisions) is DBN, and the number of inputs of image data to the driver cell in one horizontal scan period is IN. The number IN is equal to the number RN of image data read operations in one horizontal scan period described with reference to FIG. 12. In this case, the number Q of driver cells DRC1 to DRC30 arranged along the direction D2 may be expressed as “Q=HPN/(DBN×IN)”. In FIG. 13, since “HPN=240”, “DBN=4”, and “IN=2”, “Q=240/(4×2)=30”.

When the width (pitch) of the driver cells DRC1 to DR30 in the direction D2 is WD, and the width of the peripheral circuit section (e.g. buffer circuit and/or interconnect region) included in the data driver block in the direction D2 is WPCB, the width WB (maximum width) of the first to Nth circuit blocks CB1 to CBN in the direction D2 may be expressed as “Q×WD≦WB<(Q+1)×WD+WPCB”. When the width of the peripheral circuit section (e.g. row address decoder RD and/or interconnect region) included in the memory block in the direction D2 is WPC, the width WB may be expressed as “Q×WD≦WB<(Q+1)×WD+WPC”.

Suppose that the number of pixels of the display panel in the horizontal scan direction is HPN, the number of bits of image data of one pixel is PDB, the number of memory blocks is MBN (=DBN), and the number of read operations of image data from the memory block in one horizontal scan period is RN. In this case, the number P of sense amplifiers (sense amplifiers which output one bit of image data) arranged in the sense amplifier block SAB along the direction D2 may be expressed as “P=(HPN×PDB)/(MBN×RN)”. In FIG. 13, since “HPN=240”, “PDB=18”, “MBN=4”, and “RN=2”, “P=(240×18)/(4×2)=540”. The number P is the number of effective sense amplifiers corresponding to the number of effective memory cells, and does not include the number of ineffective sense amplifiers such as a dummy memory cell sense amplifier.

When the width (pitch) of each sense amplifier included in the sense amplifier block SAB in the direction D2 is WS, the width WSAB of the sense amplifier block SAB (memory block) in the direction D2 may be expressed as “WSAB=P×WS”. When the width of the peripheral circuit section included in the memory block in the direction D2 is WPC, the width WB (maximum width) of the circuit blocks CB1 to CBN in the direction D2 may also be expressed as “P×WS≦WB<(P+PDB)×WS+WPC”.

4.4 Layout of Data Driver Block

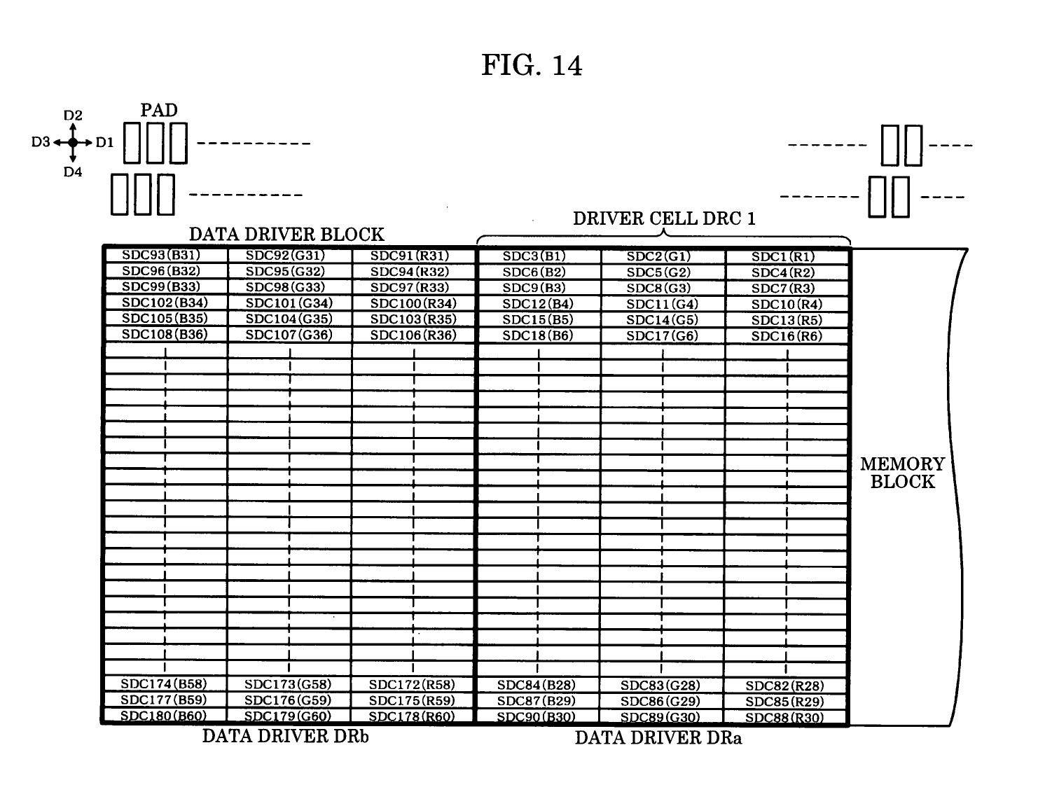

FIG. 14 shows a more detailed layout example of the data driver block. In FIG. 14, the data driver block includes a plurality of subpixel driver cells SDC1 to SDC180, each of which outputs a data signal corresponding to image data of one subpixel. In the data driver block, the subpixel driver cells are arranged along the direction D1 (direction along the long side of the subpixel driver cell) and the direction D2 perpendicular to the direction D1. Specifically, the subpixel driver cells SDC1 to SDC180 are disposed in a matrix. The pads (pad block) for electrically connecting the output lines of the data driver block with the data lines of the display panel are disposed on the D2 side of the data driver block.

For example, the driver cell DRC1 of the data driver DRa shown in FIG. 13 includes the subpixel driver cells SDC1, SDC2, and SDC3 shown in FIG. 14. The subpixel driver cells SDC1, SDC2, and SDC3 are R (red), G (green), and B (blue) subpixel driver cells, respectively. The R, G, and B image data (R1, G1, B1) corresponding to the first data signals is input to the subpixel driver cells SDC1, SDC2, and SDC3 from the memory block. The subpixel driver cells SDC1, SDC2, and SDC3 perform D/A conversion of the image data (R1, G1, B1), and output the first R, G, and B data signals (data voltages) to the R, G, and B pads corresponding to the first data lines.

Likewise, the driver cell DRC2 includes the R, G, and B subpixel driver cells SDC4, SDC5, and SDC6. The R, G, and B image data (R2, G2, B2) corresponding to the second data signals is input to the subpixel driver cells SDC4, SDC5, and SDC6 from the memory block. The subpixel driver cells SDC4, SDC5, and SDC6 perform D/A conversion of the image data (R2, G2, B2), and output the second R, G, and B data signals (data voltages) to the R, G, and B pads corresponding to the second data lines. The above description also applies to the remaining subpixel driver cells.

The number of subpixels is not limited to three, but may be four or more. The arrangement of the subpixel driver cells is not limited to the arrangement shown in FIG. 14. For example, the R, G, and B subpixel driver cells may be stacked along the direction D2.

4.5 Layout of Memory Block

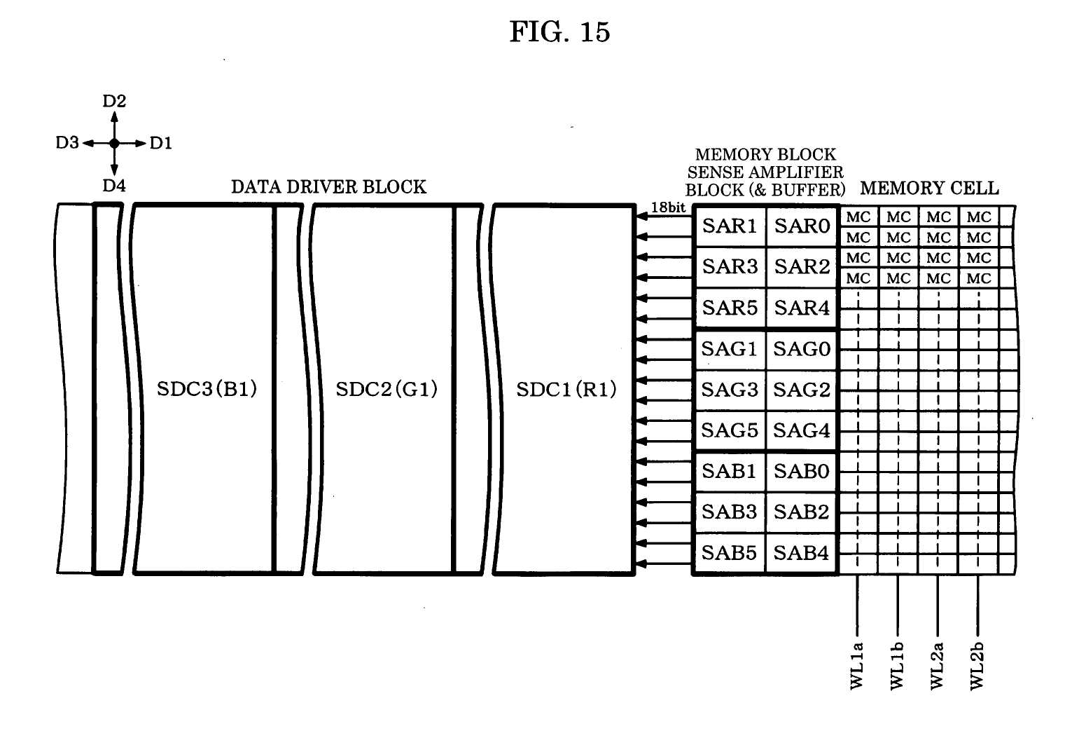

FIG. 15 shows a layout example of the memory block. FIG. 15 is a detailed view of the portion of the memory block corresponding to one pixel (six bits each for R, G, and B; 18 bits in total).

The portion of the sense amplifier block corresponding to one pixel includes R sense amplifiers SAR0 to SAR5, G sense amplifiers SAG0 to SAG5, and B sense amplifiers SAB0 to SAB5. In FIG. 15, two (a plurality of in a broad sense) sense amplifiers (and buffer) are stacked in the direction D1. Two rows of memory cells are arranged along the direction D1 on the D1 side of the stacked sense amplifiers SAR0 and SAR1, the bitline of the memory cells in the upper row being connected with the sense amplifier SAR0, and the bitline of the memory cells in the lower row being connected with the sense amplifier SAR1, for example. The sense amplifiers SAR0 and SAR1 amplify the image data signals read from the memory cells, and two bits of image data are output from the sense amplifiers SAR0 and SAR1. The above description also applies to the relationship between other sense amplifiers and memory cells.

In the configuration shown in FIG. 15, a plurality of image data read operations in one horizontal scan period shown in FIG. 12 may be realized as follows. Specifically, in the first horizontal scan period (first scan line select period), the first image data read operation is performed by selecting the wordline WL1a, and the first data signal DATAa is output as indicated by A5 in FIG. 12. In this case, R, G, and B image data from the sense amplifiers SAR0 to SAR5, SAG0 to SAG5, and SAB0 to SAB5 is respectively input to the subpixel driver cells SDC1, SDC2, and SDC3. Then, the second image data read operation is performed in the first horizontal scan period by selecting the wordline WLV1b, and the second data signal DATAb is output as indicated by A6 in FIG. 12. In this case, R, G, and B image data from the sense amplifiers SAR0 to SAR5, SAG0 to SAG5, and SAB0 to SAB5 is respectively input to the subpixel driver cells SDC91, SDC92, and SDC93 shown in FIG. 14. In the subsequent second horizontal scan period (second scan line select period), the first image data read operation is performed by selecting the wordline WL2a, and the first data signal DATAa is output. Then, the second image data read operation is performed in the second horizontal scan period by selecting the wordline WL2b, and the second data signal DATAb is output.

A modification may be made in which the sense amplifiers are not stacked in the direction D1. The rows of memory cells connected with each sense amplifier may be switched using column select signals. In this case, a plurality of image data read operations in one horizontal scan period may be realized by selecting a single wordline in the memory block a plurality of times in one horizontal scan period.

5. Pad Wiring Method

5.1 Rearrangement Wiring Region

In this embodiment, the width of the integrated circuit device in the direction D2 is reduced by using the method of disposing the subpixel driver cells SDC1 to SDC180 (driver cells) in a matrix in the directions D1 and D2, as shown in FIG. 14, to realize a narrow chip.

On the other hand, when disposing the subpixel driver cells SDC1 to SDC180 as shown in FIG. 14, it is necessary to create a method of wiring the output signal lines of the subpixel driver cells SDC1 to SDC180 to the pads.

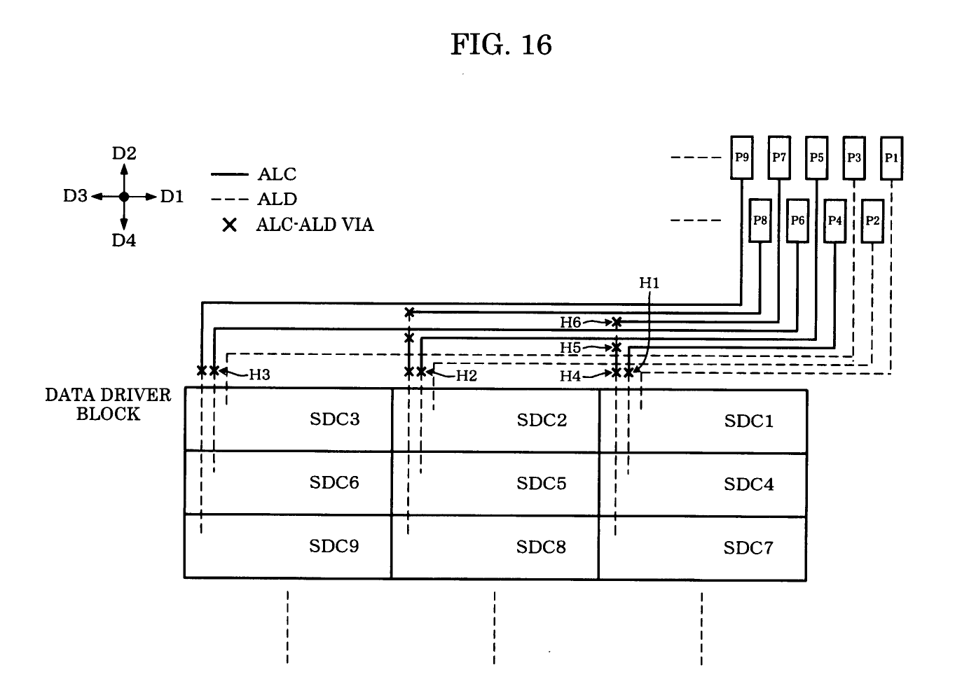

FIG. 16 shows a pad wiring method according to a comparative example. In this comparative example, the output signal lines of the subpixel driver cells SDC1, SDC2, and SDC3 are respectively connected with pads P1, P2, and P3 using a fourth aluminum wiring layer ALD. The output signal line of the subpixel driver cell SDC4 is connected with a pad P4 using a third aluminum wiring layer ALC connected with the aluminum wiring layer ALD through a via indicated by H1 in order to avoid the connection lines of the subpixel driver cells SDC2 and SDC3 formed using the aluminum wiring layer ALD. Likewise, the output signal lines of the subpixel driver cells SDC5 and SDC6 are connected with pads P5 and P6 using the aluminum wiring layer ALC through vias, as indicated by H2 and H3. The subpixel driver cell SDC7 requires that the wiring layer be changed three times, as indicated by H4, H5, and H6.

As described above, the method according to the comparative example increases the area in which the wiring layer is changed using the vias in the wiring region between the data driver block and the pads. Therefore, the width of the wiring region is increased in the direction D2 due to the large wiring layer change area and the like. As a result, the width of the integrated circuit device is increased in the direction D2, whereby a narrow chip cannot be realized.

In order to solve the above problem, this embodiment uses a method in which a rearrangement wiring region for rearranging the order of the pull-out lines of the output signals from the subpixel driver cells (driver cells) is provided in the arrangement region of the subpixel driver cells (driver cells). A change in the wiring layer as indicated by H1 to H6 in FIG. 16 can be minimized by providing the rearrangement wiring region in the arrangement region of the subpixel driver cells, whereby the width WIT of the wiring region between the data driver block and the pads in the direction D2 can be reduced. As a result, the width of the integrated circuit device in the direction D2 can be reduced, whereby a narrow chip as shown in FIG. 2B can be realized.

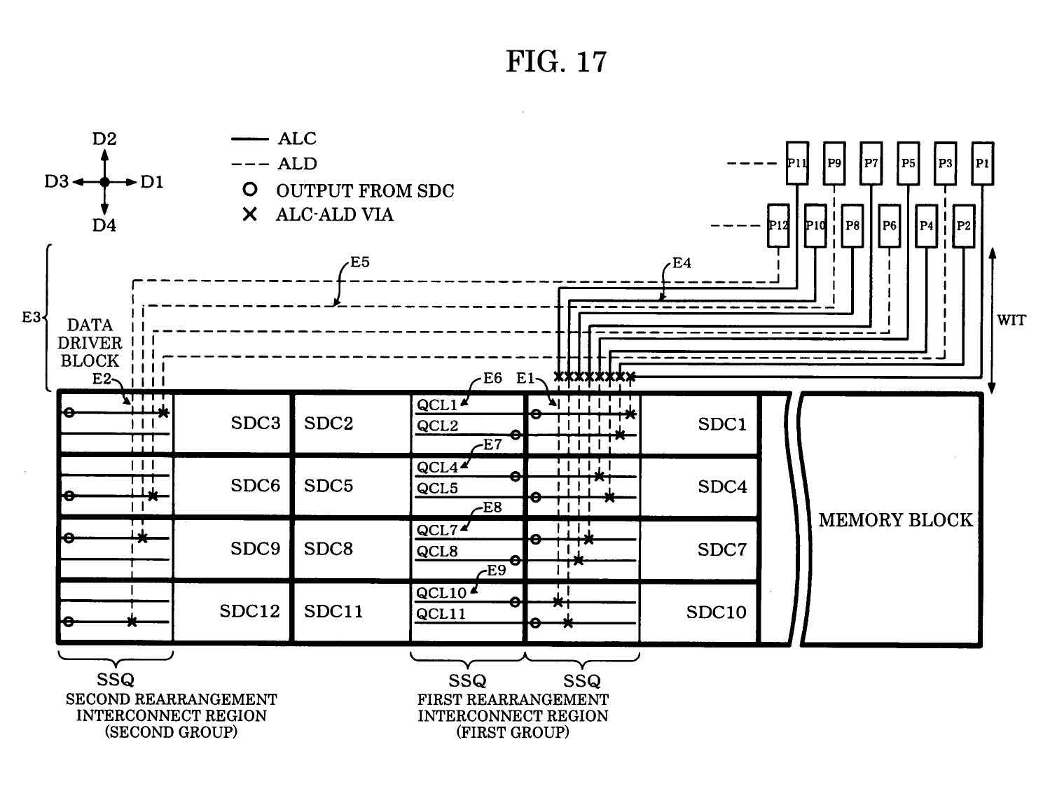

The details of the pad wiring method according to this embodiment is described below with reference to FIG. 17. As indicated by E1 and E2 in FIG. 17, the pull-out lines of the output signals (data signals) from the subpixel driver cells are provided along the direction D2 (vertical direction), for example. These pull-out lines are lines for outputting the output signals from the subpixel driver cells to the outside of the data driver block, and are formed using the fourth aluminum interconnect layer ALD, for example. The direction D1 is the direction of the long side of the subpixel driver cell, and the direction D2 is the direction of the short side of the subpixel driver cell. As shown in FIG. 17, the pads P1, P2, P3, . . . for connecting the output lines of the subpixel driver cells with the data lines of the display panel are disposed on the side of the data driver block in the direction D2.

In FIG. 17, the rearrangement wiring region (first and second rearrangement wiring regions) for rearranging the order of the pull-out lines is provided in the arrangement region of the subpixel driver cells. In more detail, the rearrangement wiring region is formed in a layer higher than first and second aluminum wiring layers ALA and ALB (local lines in the subpixel driver cells). In the rearrangement wiring region, the order of the pull-out lines is rearranged corresponding to the order of the pads. The statement “the order corresponding to the order of the pads” may be the order of the pads or an order obtained by changing the order of the pads according to a specific rule. The rearrangement wiring region refers to the wiring region formed by the pull-out lines indicated by E1 and E2 in FIG. 17 and pull-out position change lines indicated by E6 to E9 described later.

In FIG. 17, the subpixel driver cells SDC1, SDC2, SDC4, SDC5, SDC7, SDC8, . . . , of which the cell number is not a multiple of three (multiple of J in a broad sense; J is an integer of two or more) belong to a first group, and the subpixel driver cells SDC3, SDC6, SDC9, . . . of which the cell number is a multiple of three belong to a second group, for example.

The pull-out lines of the first group indicated by E1 in FIG. 17 are pull-out lines of the output signals from the subpixel driver cells SDC1, SDC2, SDC4, SDC5, SDC7, SDC8, . . . belonging to the first group. The order of the pull-out lines of the first group indicated by E1 is rearranged in the first rearrangement wiring region. In more detail, the order of the pull-out lines is rearranged in the first rearrangement wiring region in the order of the pads P1, P2, P4, P5, P7, P8, . . . . Specifically, the order of the pull-out lines is rearranged in the order of the pads excluding the pads of which the pad number is a multiple of three. Therefore, the pull-out lines of the subpixel driver cells is rearranged in the order of the subpixel driver cells SDC1, SDC2, SDC4, SDC5, SDC7, SDC8, . . . on the end (output port) of the data driver block in the direction D2.

The pull-out lines of the second group indicated by E2 in FIG. 17 are pull-out lines of the output signals from the subpixel driver cells SDC3, SDC6, SDC9, . . . belonging to the second group. The order of the pull-out lines of the second group indicated by E2 is rearranged in the second rearrangement wiring region. In more detail, the order of the pull-out lines is rearranged in the second rearrangement wiring region in the order of the pads P3, P6, P9, . . . . Specifically, the order of the pull-out lines is rearranged in the order of the pads of which the pad number is a multiple of three. This allows the pull-out lines of the subpixel driver cells to be rearranged in the order of the subpixel driver cells SDC3, SDC6, SDC9, . . . on the end (output port) of the data driver block in the direction D2.

It is possible to minimize a change in the wiring layer in the region indicated by E3, which is the wiring region between the pads and the data driver block, by providing the rearrangement wiring region in the subpixel drivers to rearrange the pull-out lines. As a result, the width WIT of the wiring region indicated by E3 in the direction D2 can be reduced in comparison with the comparative example shown in FIG. 16, whereby a narrow chip can be realized.

In this embodiment, in the wiring region indicated by E3, connection lines for connecting the pull-out lines belonging to the first group indicated by F1 with the pads P1, P2, P4, P5, P7, P8, . . . are formed using the third aluminum wiring layer ALC (wiring in a given layer in a broad sense). On the other hand, connection lines for connecting the pull-out lines belonging to the second group indicated by E2 with the pads P3, P6, P9, . . . are formed using the fourth aluminum wiring layer ALD (wiring in a layer differing from the given layer in a broad sense), as indicated by E5.

For example, the connection line indicated by E4 connects the pull-out line from the subpixel driver cell SDC10 with the pad P10. The connection line indicated by E5 connects the pull-out line from the subpixel driver cell SDC9 with the pad P9. In this case, the connection line indicated by E4 is formed using the aluminum wiring layer ALC, and the connection line indicated by E5 is formed using the aluminum wiring layer ALD in a layer differing from the aluminum wiring layer ACL. Therefore, it is unnecessary to change the wiring layer differing from the comparative example shown in FIG. 16 (indicated by H1 to H6), whereby the connection line indicated by E4 and the connection line indicated by E5 can be provided overlapped in the wiring region indicated by E3 in FIG. 17. As a result, the width WIT of the wiring region indicated by E3 can be further reduced in the direction D2, whereby a narrow chip can be realized.

5.2 Pull-Out Position Change Lines

In this embodiment, pull-out position change lines for changing the pull-out positions of the pull-out lines indicated by E1 and E2 in FIG. 17 are provided in the rearrangement wiring regions. For example, lines QCL1 and QCL2 indicated by E6 in FIG. 17 are pull-out position change lines for changing the pull-out positions of the output signals (output lines) of the subpixel driver cells SDC1 and SDC2. Likewise, lines QCL4 and QCL5 indicated by E7 are pull-out position change lines for the subpixel driver cells SDC4 and SDC5, lines QCL7 and QCL8 indicated by E8 are pull-out position change lines for the subpixel driver cells SDC7 and SDC8, and lines QCL10 and QCL11 indicated by E9 are pull-out position change lines for the subpixel driver cells SDC10 and SDC11.

The pull-out position change lines QCL1 and QCL2 are provided in the direction D1 (horizontal direction) across the subpixel driver cells SDC1 and SDC2 disposed along the direction D1, as indicated by E6. Specifically, two pull-out position change lines QCL1 and QCL2 are provided across two subpixel driver cells SDC1 and SDC2 disposed along the direction D1. This allows the output signals from the subpixel driver cells SDC1 and SDC2 to be output from arbitrary positions of the first rearrangement wiring region along the direction D1 using the pull-out lines. Specifically, the pull-out position change lines QCL1 and QCL2 are formed using the third aluminum wiring layer ALC. Therefore, if the vias connecting the aluminum wiring layers ALC and ALD are formed at arbitrary positions of the pull-out position change lines QCL1 and QCL2 provided along the direction D1, the pull-out lines formed using the aluminum wiring layer ALD can be provided along the direction D2 from the via formation positions. This allows the pull-out line to be provided along the direction D2 from an arbitrary pull-out position in the direction D1, whereby the order of the pull-out lines can be easily rearranged.

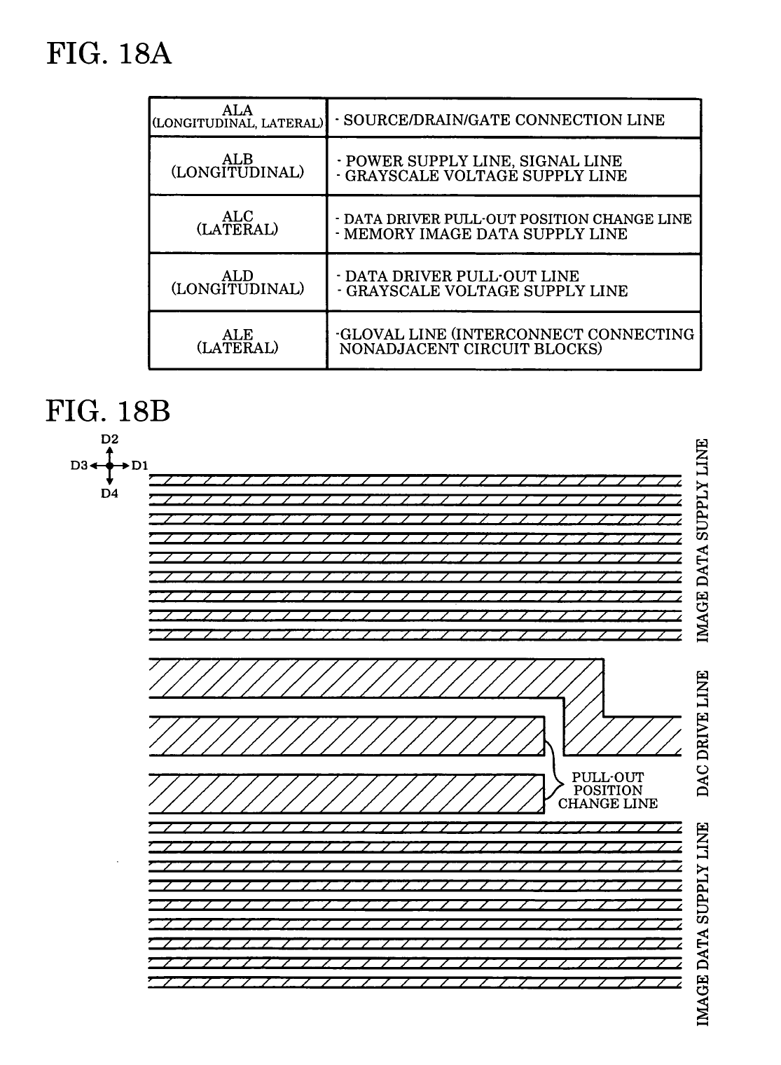

FIG. 18A shows an example of usage of each aluminum wiring layer. For example, the first aluminum wiring layer ALA provided in the longitudinal or lateral direction is used as source/drain/gate connection lines of transistors of the circuit block and the like. The second aluminum wiring layer ALB mainly provided in the longitudinal direction is used as the power supply line, signal line, grayscale voltage supply line, and the like. The third aluminum wiring layer ALC mainly provided in the lateral direction is used as the pull-out position change line of the data driver, image data supply line of the memory, and the like. The fourth aluminum wiring layer ALD mainly provided in the longitudinal direction is used as the pull-out line of the data driver, grayscale voltage supply line, and the like. The fifth aluminum wiring layer ALE (top metal) mainly provided in the lateral direction is used as a global line which connects nonadjacent circuit blocks and the like.

FIG. 18B shows a layout example of the aluminum wiring layer ALC provided in the subpixel driver cell. In FIG. 18B, the pull-out position change line and the DAC drive line are provided along the direction D1 (lateral direction) using the wide aluminum wiring layer ALC. Eighteen image data supply lines for one pixel are provided along the direction D1 using the aluminum wiring layer ALC, for example. A number of image data supply lines and the pull-out position change lines indicated by E6 in FIG. 17 and the like are provided in the subpixel driver cell using the aluminum wiring layer ALC in this manner.

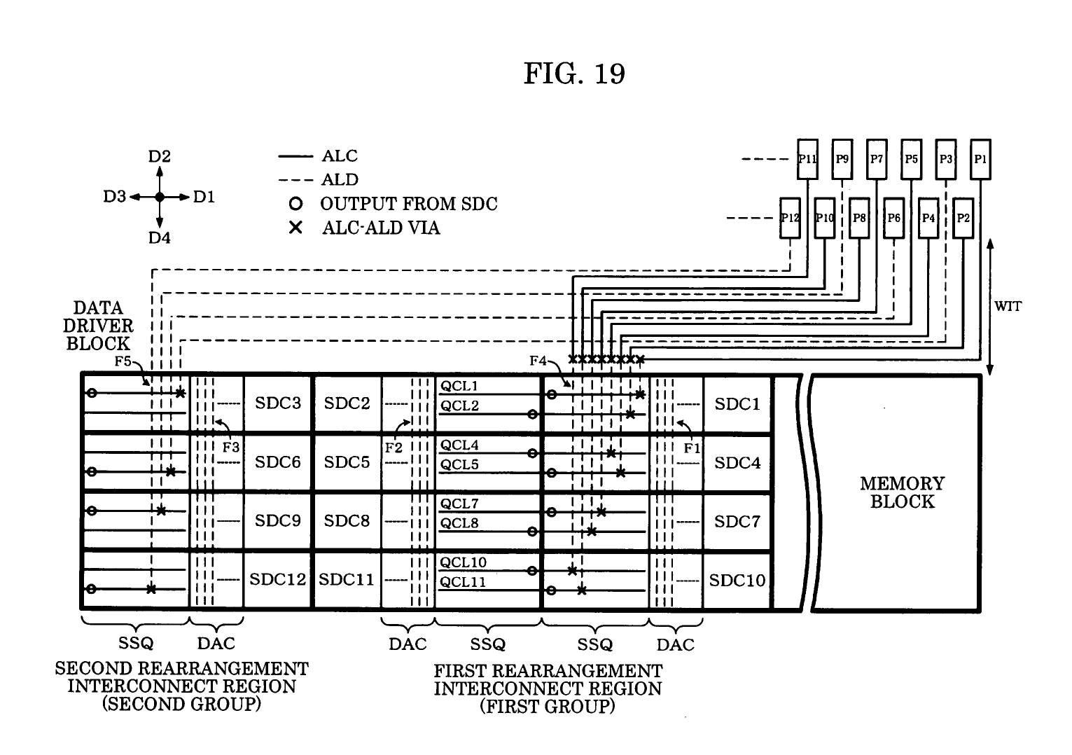

In this embodiment, the grayscale voltage supply lines for supplying the grayscale voltages to the D/A converters DAC of the subpixel driver cells are provided along the direction D2 across the subpixel driver cells, as indicated by F1, F2, and F3 in FIG. 19. In more detail, the grayscale voltage supply lines indicated by F1, F2, and F3 are provided using the aluminum wiring layer ALD which is used for the pull-out lines indicated by F4 and F5. Specifically, the grayscale voltage supply lines indicated by F1, F2, and F3 are provided by effectively utilizing the free space in which the pull-out lines indicated by F4 and F5 are not disposed.

In this embodiment, the pull-out position change lines and the image data supply lines are provided along the direction D1 (lateral direction) using the aluminum wiring layer ALC. On the other hand, the pull-out lines and the grayscale voltage supply lines are provided along the direction D2 (longitudinal direction) using the aluminum wiring layer ALD differing from the aluminum wiring layer ALC. This allows the pull-out position change lines, the image data supply lines, the pull-out lines, and the grayscale voltage supply lines to be efficiently provided using the aluminum wiring layers ALC and ALD. Therefore, since the remaining aluminum wiring layer such as the aluminum wiring layer ALE can be used for the global lines and the like, whereby the wiring efficiency can be increased. As a result, an increase in the width of the data driver block in the directions D1 and D2 can be minimized, whereby a narrow chip can be realized and the area of the integrated circuit device can be reduced.

In this embodiment, the rearrangement wiring region is provided in the region of the output sections SSQ of the subpixel driver cells. For example, the first rearrangement wiring region is provided in the region of the output sections SSQ of the subpixel driver cells SDC1, SDC2, SDC4, SDC5, SDC7, SDC8, . . . belonging to the first group, as shown in FIG. 19. The second rearrangement wiring region is provided in the region of the output sections SSQ of the subpixel driver cells SDC3, SDC6, SDC9, . . . belonging to the second group. This allows the order of the pull-out lines to be rearranged by effectively utilizing the region of the output sections SSQ of the subpixel driver cells. Specifically, the grayscale voltage supply lines can be provided in the region of the D/A converters DAC on each side of the output sections SSQ, as indicated by F1, F2, and F3, by providing the pull-out lines in the region of the output sections SSQ using the region of the output sections SSQ as the rearrangement wiring region, as indicated by F4 and F5 in FIG. 19. Therefore, the pull-out lines and the grayscale voltage supply lines can be provided using a single aluminum wiring layer ALD, whereby the wiring efficiency can be increased.

5.3 Layout of Subpixel Driver Cell

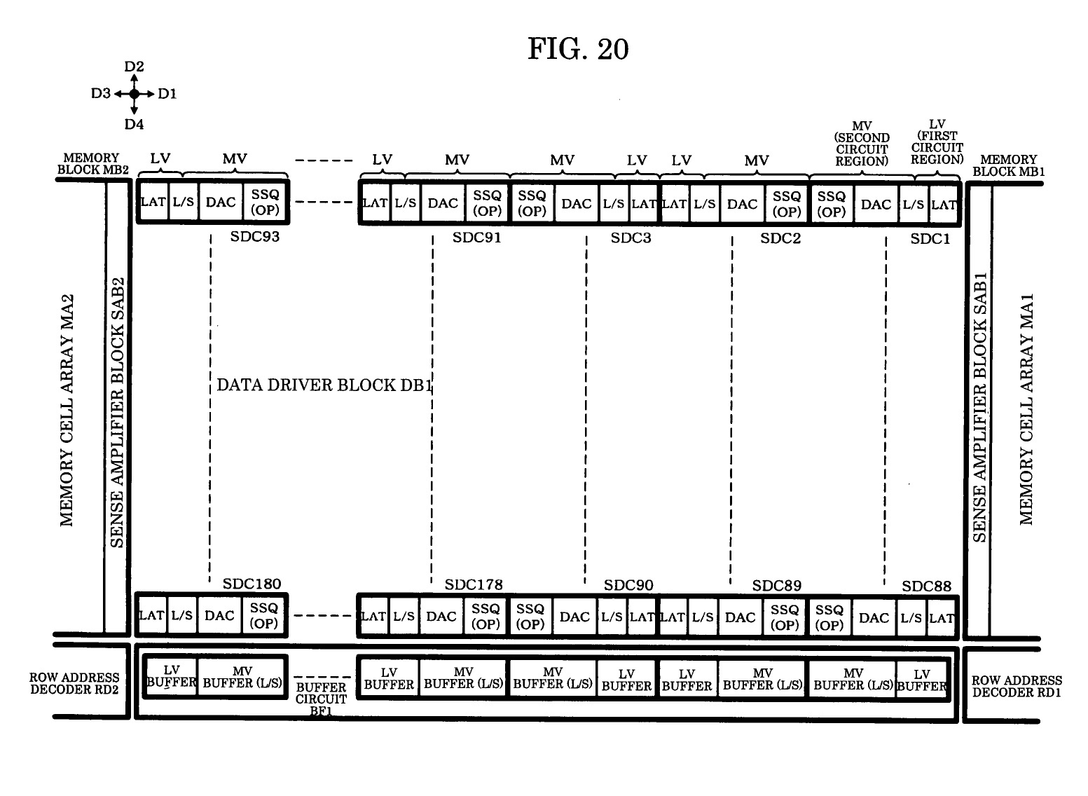

FIG. 20 shows a detailed layout example of the subpixel driver cells. As shown in FIG. 20, each of the subpixel driver cells SDC1 to SDC180 includes a latch circuit LAT, a level shifter L/S, a D/A converter DAC, and an output section SSQ. Another logic circuit such as a grayscale-control frame rate control (FRC) circuit may be provided between the latch circuit LAT and the level shifter L/S.

The latch circuit LAT included in each subpixel driver cell latches six-bit image data of one subpixel from the memory block MB1. The level shifter L/S converts the voltage level of the six-bit image data signal from the latch circuit LAT. The D/A converter DAC performs D/A conversion of the six-bit image data using the grayscale voltage. The output section SSQ includes a (voltage-follower-connected) operational amplifier OP which performs impedance conversion of the output signal from the D/A converter DAC, and drives one data line corresponding to one subpixel. The output section SSQ may include a discharge transistor (switch element), an eight-color-display transistor, and a DAC driver transistor in addition to the operational amplifier OP.

As shown in FIG. 20, each subpixel driver cell includes an LV region (first circuit region in a broad sense) in which a circuit which operates using a power supply at a low voltage (LV) level (first voltage level in a broad sense) is disposed, and an MV region (second circuit region in a broad sense) in which a circuit which operates using a power supply at a middle voltage (MV) level (second voltage level in a broad sense) higher than the LV level is disposed. The low voltage (LV) is the operating voltage of the logic circuit block LB, the memory block MB, and the like. The middle voltage (MV) is the operating voltage of the D/A converter, the operational amplifier, the power supply circuit, and the like. The output transistor of the scan driver is provided with a power supply at a high voltage (HV) level (third voltage level in a broad sense) to drive the scan line.

For example, the latch circuit LAT (or another logic circuit) is disposed in the LV region (first circuit region) of the subpixel driver cell. The D/A converter DAC and the output section SSQ including the operational amplifier OP are disposed in the MV region (second circuit region). The level shifter L/S converts the LV level signal into an MV level signal.

In FIG. 20, a buffer circuit BF1 is provided on the D4 side of the subpixel driver cells SDC1 to SDC180. The buffer circuit BF1 buffers a driver control signal from the logic circuit block LB, and outputs the driver control signal to the subpixel driver cells SDC1 to SDC180. In other words, the buffer circuit BF1 functions as a driver control signal repeater block.

In more detail, the buffer circuit BF1 includes an LV buffer disposed in the LV region and an MV buffer disposed in the MV region. The LV buffer receives and buffers the LV level driver control signal (e.g. latch signal) from the logic circuit block LB, and outputs the driver control signal to the circuit (LAT) disposed in the LV region of the subpixel driver cell on the D2 side of the LV buffer. The MV buffer receives the LV level driver control signal (e.g. DAC control signal or output control signal) from the logic circuit block LB, converts the LV level driver control signal into an MV level driver control signal using a level shifter, buffers the converted signal, and outputs the buffered signal to the circuit (DAC and SSQ) disposed in the MV region of the subpixel driver cell on the D2 side of the MV buffer.

In this embodiment, the subpixel driver cells SDC1 to SDC180 are disposed so that the MV regions (or LV regions) of the subpixel driver cells are adjacent to each other along the direction D1, as shown in FIG. 20. Specifically, the adjacent subpixel driver cells are mirror-image disposed on either side of the boundary extending along the direction D2. For example, the subpixel driver cells SDC1 and SDC2 are disposed so that the MV regions are adjacent to each other. The subpixel driver cells SDC3 and SDC91 are disposed so that the MV regions are adjacent to each other. The subpixel driver cells SDC2 and SDC3 are disposed so that the LV regions are adjacent to each other.

It is unnecessary to provide a guard ring or the like between the subpixel driver cells by disposing the subpixel driver cells so that the MV regions are adjacent to each other, as shown in FIG. 20. Therefore, the width of the data driver block in the direction D1 can be reduced in comparison with a method of disposing the subpixel driver cells so that the MV region is adjacent to the LV region, whereby the area of the integrated circuit device can be reduced.

According to the arrangement method shown in FIG. 20, the MV regions of the adjacent subpixel driver cells (driver cells) can be effectively utilized as the wiring region of the pull-out lines of the output signals from the subpixel driver cells, whereby the layout efficiency can be improved.

According to the arrangement method shown in FIG. 20, the memory block can be disposed adjacent to the LV region (first circuit region) of the subpixel driver cell. In FIG. 20, the memory block MB1 is disposed adjacent to the LV regions of the subpixel driver cells SDC1 and SDC88, for example. The memory block MB2 is disposed adjacent to the LV regions of the subpixel driver cells SDC93 and SDC180. The memory blocks MB1 and MB2 operate using a power supply at the LV level. Therefore, the width of the driver macrocell in the direction D1 including the data driver block and the memory block can be reduced by disposing the data driver block and the memory block so that the LV region of the subpixel driver cell is adjacent to the memory block, whereby the area of the integrated circuit device can be reduced.

5.4 D/A Converter

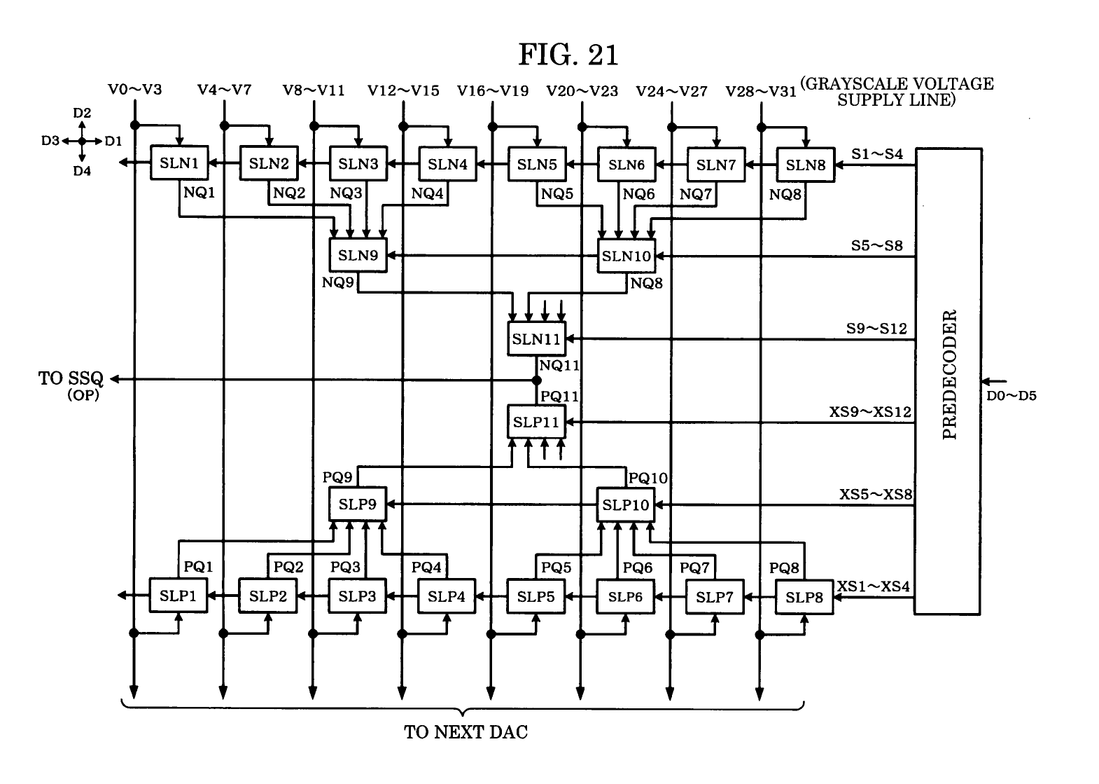

FIG. 21 shows a detailed configuration example of the D/A converter (DAC) included in the subpixel driver cell. This D/A converter is a circuit which performs tournament type D/A conversion, and includes grayscale voltage selectors SLN1 to SLN11 and SLP1 to SLP11 and a predecoder 120.

The grayscale voltage selectors SLN1 to SLN11 are selectors formed of N-type (first conductivity type in a broad sense) transistors, and the grayscale voltage selectors SLP1 to SLP11 are selectors formed of P-type (second conductivity type in a broad sense) transistors. The N-type and P-type transistors make a pair to form a transfer gate. For example, the N-type transistor which forms the grayscale voltage selector SLN1 and the P-type transistor which forms the grayscale voltage selector SLP1 make a pair to form a transfer gate.

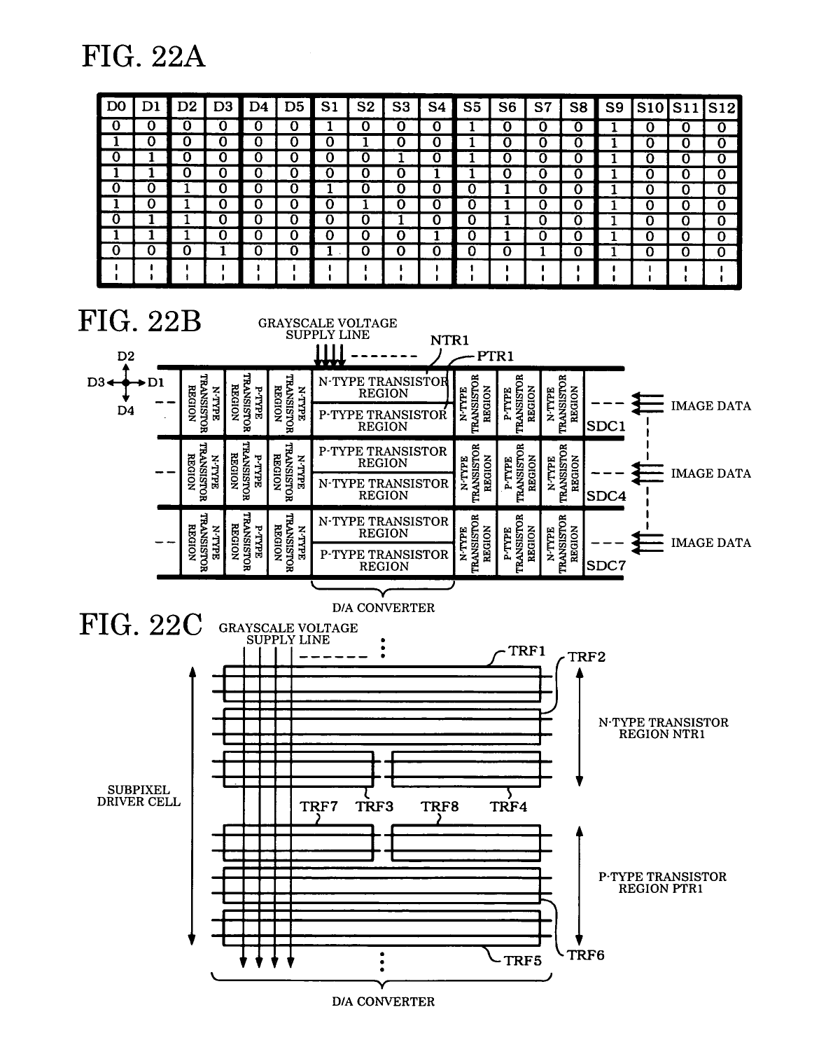

The grayscale voltage supply lines for the grayscale voltages V0 to V3, V4 to V7, V8 to V11, V12 to V15, V16 to V19, V20 to V23, V24 to V27, and V28 to V31 are respectively connected with input terminals of the grayscale voltage selectors SLN1 to SLN8 and SLP1 to SLP8. The predecoder 120 is provided with image data D0 to D5, and decodes the image data D0 to D5 as indicated by the truth table shown in FIG. 22A. The predecoder 120 outputs select signals S1 to S4 and XS1 to XS4 to the grayscale voltage selectors SLN1 to SLN8 and SLP1 to SLP9, respectively. The predecoder 120 outputs select signals S5 to S8 and XS5 to XS8 to the grayscale voltage selectors SLN9 and SLN10 and SLP9 and SLP10, respectively, and outputs select signals S9 to S12 and XS9 to XS12 to the grayscale voltage selectors SLN11 and SLP11, respectively.

For example, when the image data D0 to D5 is (100000), the select signals S2, S5, and S9 (XS2, XS5, and XS9) are set to active, as shown in the truth table in FIG. 22A. This allows the grayscale voltage selectors SLN1 and SLP1 to select the grayscale voltage V1, the grayscale voltage selectors SLN9 and SLP9 to select the outputs from the grayscale voltage selectors SLN1 and SLP1, and the grayscale voltage selectors SLN11 and SLP11 to select the outputs from the grayscale voltage selectors SLN9 and SLP9. Therefore, the grayscale voltage V1 is output to the output section SSQ. Likewise, when the image data D0 to D5 is (010000), since the select signal S3 (XS3) is set to active, the grayscale voltage selectors SLN1 and SLP1 select the grayscale voltage V2, and the grayscale voltage V2 is output to the output section SSQ. When the image data D0 to D5 is (001000), the select signals S1, S6, and S9 (XS1, XS6, and XS9) are set to active. Therefore, the grayscale voltage selectors SLN2 and SLP2 select the grayscale voltage V4, the grayscale voltage selectors SLN9 and SLP9 select the outputs from the grayscale voltage selectors SLN2 and SLP2, and the grayscale voltage selectors SLN11 and SLP11 select the outputs from the grayscale voltage selectors SLN9 and SLP9. Therefore, the grayscale voltage V4 is output to the output section SSQ.

In this embodiment, as shown in FIGS. 22B and 22C, the grayscale voltage supply lines for supplying the grayscale voltages V0 to V31 to the D/A converter shown in FIG. 21 are provided along the direction D2 (D4) across the subpixel driver cells. In FIG. 22B, the grayscale voltage supply lines are provided in the direction D2 across the subpixel driver cells SDC1, SDC4, and SDC7 arranged along the direction D2, for example. As shown in FIGS. 22B and 22C, the grayscale voltage supply lines are provided in the arrangement region in which the D/A converter (grayscale voltage selector) is disposed.

In more detail, as shown in FIG. 22B, an N-type transistor region (P-type well) and a P-type transistor region (N-type well) are disposed along the direction D2 in the arrangement region of the subpixel driver cell in which the D/A converter is disposed. On the other hand, an N-type transistor region (P-type well) and a P-type transistor region (N-type well) are disposed along the direction D1 perpendicular to the direction D2 in the arrangement region of a circuit (output section, level shifter, and latch circuit) of the subpixel driver cell other than the D/A converter is disposed. In other words, the subpixel driver cells adjacent along the direction D2 are mirror-image disposed on either side of the boundary extending along the direction D1. For example, the driver cells SDC1 and SDC4 are mirror-image disposed on either side of the boundary between the driver cells SDC1 and SDC4, and the driver cells SDC4 and SDC7 are mirror-image disposed on either side of the boundary between the driver cells SDC4 and SDC7.

For example, the N-type transistors forming the grayscale voltage selectors SLN1 to SLN11 of the D/A converter of the subpixel driver cell SDC1 are formed in an N-type transistor region NTR1 of the subpixel driver cell shown in FIG. 22B, and the P-type transistors forming the grayscale voltage selectors SLP1 to SLP11 are formed in a P-type transistor region PTR1. In more detail, as shown in FIG. 22C, N-type transistors TRF1 and TRF2 forming the grayscale voltage selector SLN11 and N-type transistors TRF3 and TRF4 forming the grayscale voltage selectors SLN9 and SLN10 are formed in the N-type transistor region NTR1. On the other hand, P-type transistors TRF5 and TRF6 forming the grayscale voltage selector SLP11 and P-type transistors TRF7 and TRF8 forming the grayscale voltage selectors SLP9 and SLP10 are formed in the P-type transistor region PTR1. While the N-type transistor region and the P-type transistor region of other circuits of the subpixel driver cell are disposed along the direction D1, the N-type transistor region NTR1 and the P-type transistor region PTR1 are disposed along the direction D2.

In the D/A converter shown in FIG. 21, the N-type transistor forming the grayscale voltage selector SLN1 and the P-type transistor forming the grayscale voltage selector SLP1 make a pair to form a transfer gate, for example. Therefore, the grayscale voltage supply lines can be connected in common with these P-type and N-type transistors by providing the grayscale voltage supply lines along the direction D2, whereby the transfer gate can be easily formed. Therefore, the layout efficiency can be improved.

On the other hand, it is necessary to input image data from the memory block to a circuit (e.g. latch circuit) other than the D/A converter. As shown in FIG. 22B, the image data is supplied through an image data supply line provided along the direction D1. As is clear from the layout shown in FIG. 20, the signal flow direction in the subpixel driver cell is the direction D1. Therefore, an efficient layout along the signal flow can be achieved by arranging the N-type transistor region and the P-type transistor region of the circuits other than the D/A converter along the direction D1, as shown in FIG. 22B. Therefore, the transistor region arrangement as shown in FIG. 22B is the layout optimum for the subpixel driver cells disposed as shown in FIG. 20.

6. Electronic Instrument

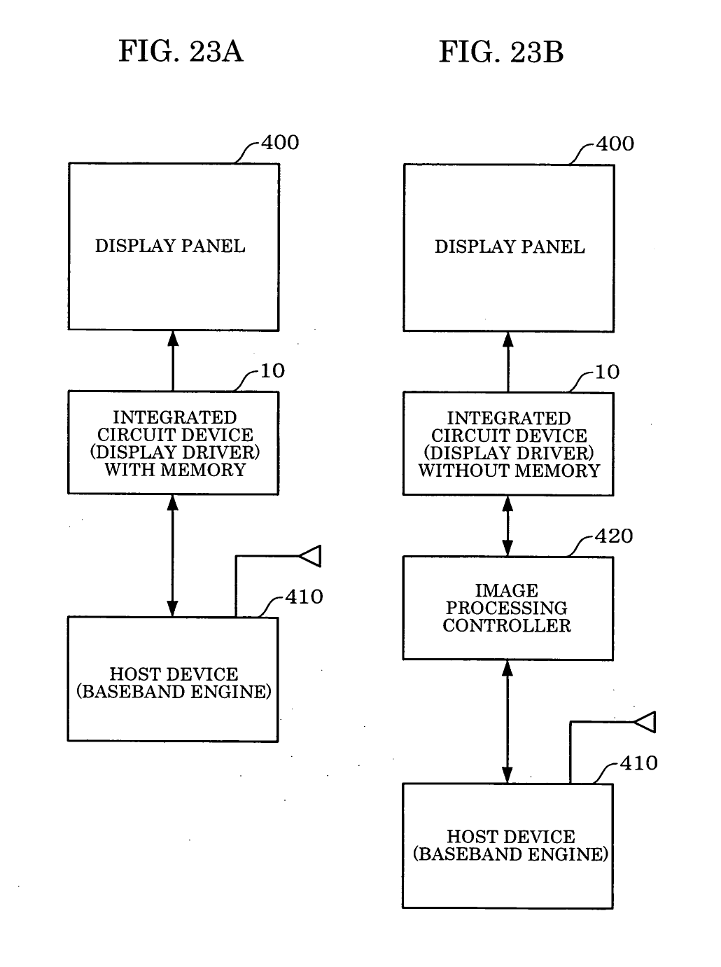

FIGS. 23A and 23B show examples of an electronic instrument (electro-optical device) including the integrated circuit device 10 according to the above embodiment. The electronic instrument may include constituent elements (e.g. camera, operation section, or power supply) other than the constituent elements shown in FIGS. 23A and 23B. The electronic instrument according to this embodiment is not limited to a portable telephone, and may be a digital camera, PDA, electronic notebook, electronic dictionary, projector, rear-projection television, portable information terminal, or the like.

In FIGS. 23A and 23B, a host device 410 is a microprocessor unit (MPU), a baseband engine (baseband processor), or the like. The host device 410 controls the integrated circuit device 10 as a display driver. The host device 410 may perform processing as an application engine and a baseband engine or processing as a graphic engine such as compression, decompression, or sizing. An image processing controller (display controller) 420 shown in FIG. 23B performs processing as a graphic engine such as compression, decompression, or sizing instead of the host device 410.

A display panel 400 includes a plurality of data lines (source lines), a plurality of scan lines (gate lines), and a plurality of pixels specified by the data lines and the scan lines. A display operation is realized by changing the optical properties of an electro-optical element (liquid crystal element in a narrow sense) in each pixel region. The display panel 400 may be formed by an active matrix type panel using switch elements such as a TFT or TFD. The display panel 400 may be a panel other than an active matrix type panel, or may be a panel other than a liquid crystal panel.

In FIG. 23A, the integrated circuit device 10 may include a memory. In this case, the integrated circuit device 10 writes image data from the host device 410 into the built-in memory, and reads the written image data from the built-in memory to drive the display panel. In FIG. 23B, the integrated circuit device 10 may not include a memory. In this case, image data from the host device 410 is written into a memory provided in the image processing controller 420. The integrated circuit device 10 drives the display panel 400 under control of the image processing controller 420.

Although only some embodiments of the invention have been described in detail above, those skilled in the art will readily appreciate that many modifications are possible In this embodiments without departing from the novel teachings and advantages of this invention. Accordingly, all such modifications are intended to be included within the scope of this invention. For example, any term (such as the output-side I/F region, the input-side I/F region, the LV region and the MV region) cited with a different term having broader or the same meaning (such as the first interface region, the second interface region, the first circuit region, and the second circuit region) at least once in this specification or drawings can be replaced by the different term in any place in this specification and drawings.

The methods according to the above embodiments such as providing the rearrangement wiring region in the arrangement region of the subpixel driver cells may also be applied to an integrated circuit device having an arrangement and a configuration differing from those shown in FIG. 3. The first and second directions of the integrated circuit device need not necessarily coincide with the first and second directions of the subpixel driver cell.

What is claimed is:

1. An integrated circuit device comprising at least one data driver block for driving data lines, the data driver block including;
a plurality of subpixel driver cells, each of the subpixel driver cells outputting a data signal corresponding to image data of one subpixel,
when a direction along a long side of the subpixel driver cell is a first direction and a direction perpendicular to the first direction is a second direction, the subpixel driver cells being disposed in the data driver block along the first direction and the second direction,
pads for electrically connecting output lines of the data driver block with the data lines being disposed on the second direction side of the data driver block,
a rearrangement wiring region for rearranging order of pull-out lines of output signals from the subpixel driver cells being provided in an arrangement region of the subpixel driver cells.

2. The integrated circuit device as defined in claim 1, wherein the order of the pull-out lines is rearranged in the rearrangement wiring region corresponding to order of the pads.

3. The integrated circuit device as defined in claim 1,
wherein the order of the pull-out lines belonging to a first group is rearranged in a first rearrangement wiring region, the pull-out lines belonging to the first group being the pull-out lines of the output signals from the subpixel driver cells belonging to a first group; and
wherein the order of the pull-out lines belonging to a second group is rearranged in a second rearrangement wiring region, the pull-out lines belonging to the second group being the pull-out lines of the output signals from the subpixel driver cells belonging to a second group.

4. The integrated circuit device as defined in claim 3, wherein, in a wiring region between an arrangement region of the pads and the data driver block, connection lines for connecting the pull-out lines belonging to the first group and the pads are provided using wiring in a given layer, and connection lines for connecting the pull-out lines belonging to the second group and the pads are provided using wiring in a layer differing from the given layer.

5. The integrated circuit device as defined in claim 1, wherein a pull-out position change line for changing a pull-out position of the pull-out line is provided in the rearrangement wiring region.

6. The integrated circuit device as defined in claim 5, wherein the pull-out position change line is provided along the first direction across the subpixel driver cells disposed along the first direction.

7. The integrated circuit device as defined in claim 6, wherein two of the pull-out position change lines are provided across two of the subpixel driver cells disposed along the first direction.

8. The integrated circuit device as defined in claim 5, wherein an image data supply line for supplying image data to the subpixel driver cell is provided in the subpixel driver cell along the first direction using wiring in the same layer as the pull-out position change line.

9. The integrated circuit device as defined in claim 6, wherein an image data supply line for supplying image data to the subpixel driver cell is provided in the subpixel driver cell along the first direction using wiring in the same layer as the pull-out position change line.

10. The integrated circuit device as defined in claim 5, wherein the pull-out line is provided along the second direction using wiring in a layer differing from the pull-out position change line.

11. The integrated circuit device as defined in claim 6, wherein the pull-out line is provided along the second direction using wiring in a layer differing from the pull-out position change line.

12. The integrated circuit device as defined in claim 8, wherein the pull-out line is provided along the second direction using wiring in a layer differing from the pull-out position change line.

13. The integrated circuit device as defined in claim 9, wherein the pull-out line is provided along the second direction using wiring in a layer differing from the pull-out position change line.

14. The integrated circuit device as defined in claim 1,
wherein the subpixel driver cell includes a D/A converter which performs D/A conversion of image data using a grayscale voltage; and
wherein a grayscale voltage supply line for supplying the grayscale voltage to the D/A converter is provided in the data driver block along the second direction across the subpixel driver cells using wiring in the same layer as the pull-out line.

15. The integrated circuit device as defined in claim 14, wherein the grayscale voltage supply line is provided in an arrangement region of the D/A converter.

16. The integrated circuit device as defined in claim 14,
wherein an N-type transistor region and a P-type transistor region are disposed along the second direction in an arrangement region of the D/A converter of the subpixel driver cell; and
wherein an N-type transistor region and a P-type transistor region are disposed along the first direction in an arrangement region of a circuit of the subpixel driver cell other than the D/A converter.

17. The integrated circuit device as defined in claim 1,
wherein each of the subpixel driver cells includes:
a first circuit region in which a circuit which operates using a power supply at a first voltage level is disposed; and
a second circuit region in which a circuit which operates using a power supply at a second voltage level higher than the first voltage level is disposed; and
wherein the subpixel driver cells are disposed so that the second circuit regions or the first circuit regions of the subpixel driver cells are adjacent to each other along the first direction.

18. The integrated circuit device as defined in claim 17, comprising:
at least one memory block which stores image data;
wherein the memory block is disposed adjacent to the first circuit region of the subpixel driver cell.

19. An electronic instrument comprising:
the integrated circuit device as defined in claim 1; and
a display panel driven by the integrated circuit device.
